(19) United States
(12) Patent Application Publication
(10) Pub. No.: US 2024/0137834 A1
(43) Pub. Date: Apr. 25, 2024

(54) FIRST NODE, SECOND NODE, THIRD NODE, AND METHODS PERFORMED THEREBY IN A COMMUNICATIONS NETWORK TO HANDLE A PATH FOR A PACKET

(71) Applicant: Telefonaktiebolaget LM Ericsson (publ), Stockholm (SE)

(72) Inventors: Lackis ELEFTHERIADIS, Valbo (SE); Ajmal MUHAMMAD, Sollentuna (SE)

(73) Assignee: Telefonaktiebolaget LM Ericsson (publ), Stockholm (SE)

(21) Appl. No.: 18/275,274

(22) PCT Filed: Feb. 2, 2021
(86) PCT No.: PCT/EP2021/052437

§ 371 Date: Jul. 31, 2023

(51) Int. Cl. H04W 40/08

(52) U.S. Cl. CPC H04W 40/08

(57) ABSTRACT

A computer-implemented method performed by a first node (111). The first node (111) operates in a communications network (100). The first node (111) obtains (501), from another node (112, 113) operating in the communications network (100), a respective indication. The respective indication is of a respective efficiency measure of power use of a plurality of nodes (110) operating in the communications network (100) along at least two paths (151, 152). The first node (111) then selects (502) a path for a first packet in the communications network (100), among the at least two paths (151, 152), based on the obtained respective indication.

### TECHNICAL FIELD

The present disclosure relates generally to a first node and methods performed thereby for handling a path for packet in a communications network. The present disclosure relates generally to a second node and methods performed thereby for handling a path for a packet in a communications network. The present disclosure relates generally to a third node and methods performed thereby for handling a path for a packet in a communications network.

### BACKGROUND

Nodes within a communications network may be wireless devices such as e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone, and/or between a wireless device and a server via a Radio Access Network (RAN), and possibly one or more core networks, comprised within the communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

Nodes may also be network nodes, such as radio network nodes, e.g., Transmission Points (TP). The communications network covers a geographical area which may be divided into cell areas, each cell area being served by a network node such as a Base Station (BS), e.g. a Radio Base Station (RBS), which sometimes may be referred to as e.g., gNB, evolved Node B (“eNB”), “eNodeB”, “NodeB”, “B node”, or BTS (Base Transceiver Station), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The so-called 5th Generation (5G) system, from a radio perspective started to be standardized in 3GPP, and the so-called New Radio (NR) is the name for the radio interface. NR architecture is being discussed in 3GPP. In the current concept, gNB denotes NR BS, where one NR BS may correspond to one or more transmission/reception points. The expression Uplink (UL) may be used for the transmission path in the opposite direction i.e., from the wireless device to the base station.

Integrated Access Backhaul Networks

3GPP has standardized Integrated Access and Backhaul (IAB) in NR in Rel-16 (RP-182882).

The usage of short range mmWave spectrum in NR may be understood to create a need for densified deployment with multi-hop backhauling. However, optical fiber to every base station will be too costly and sometimes not even possible, e.g., in historical sites. The main IAB principle may be understood to be the use of wireless links for the backhaul, instead of fiber, to enable flexible and very dense deployment of cells without the need for densifying the transport network. Use case scenarios for IAB may include coverage extension, deployment of massive number of small cells and Fixed Wireless Access (FWA), e.g., to residential/office buildings. The larger bandwidth available for NR in mmWave spectrum may be understood to provide an opportunity for self-backhauling, without limiting the spectrum to be used for the access links. On top of that, the inherent multi-beam and Multiple Input Multiple Output (MIMO) support in NR may reduce cross-link interference between backhaul and access links allowing higher densification.

During the study item phase of the IAB work, a summary of which study item may be found in the technical report TR 38.874, v. 16.0.0 [1], it has been agreed to adopt a solution that leverages the Central Unit (CU)/Distributed Unit (DU) split architecture of NR, where the IAB node may be hosting a DU part that may be controlled by a central unit. The IAB nodes may be also have a Mobile Termination (MT) part that they use to communicate with their parent nodes.

The specifications for IAB, strive to reuse existing functions and interfaces defined in NR. In particular, MT, gNB Distribution Unit (gNB-DU), gNB Centralized Unit (gNB-CU), User Plane Function (UPF), Access and Mobility Management Function (AMF) and Session Management Function (SMF), as well as the corresponding interfaces NR-Uu, between MT and gNB, F1, between gNB-CU and gNB-DU, NG, between RAN and Core, X2, between two gNBs, and N4, between SMF and UPF, are used as baseline for the IAB architectures. Modifications or enhancements to these functions and interfaces for the support of IAB will be explained in the context of the architecture discussion. Additional functionality such as multi-hop forwarding is included in the architecture discussion as may be understood to be necessary for the understanding of IAB operation and since certain aspects may require standardization.

The Mobile-Termination (MT) function has been defined as a component of the IAB node. In the context of this study, MT is referred to as a function residing on an IAB-node that terminates the radio interface layers of the backhaul Uu interface toward the IAB-donor or other IAB-nodes.

FIG. 1 is a schematic diagram showing a high-level architectural view of an IAB network. In FIG. 1, a multi-hop IAB deployment is presented, where the IAB donor node, in short IAB donor, may be understood to have a wired connection to the core network (CN) and the IAB relay nodes, in short IAB nodes, may be understood to be wirelessly connected to the IAB donor, either directly, understood as a single hop, or indirectly via other IAB nodes, understood as a multi-hop. The connection between IAB donor/node and UEs may be referred to as access link, whereas the connection between two IAB nodes or between an IAB donor and an IAB node may be referred to as access and backhaul link. For the IAB network, the backhaul links may be realized as NR wireless links. The IAB donor and some of the IAB nodes may serve not only the User Equipment (UE) traffic within the serving range over the access link, but also the aggregated traffic from/to the child nodes, which may also be referred to as IAB nodes, over the backhaul link.

When an IAB node is turned on, its parent node, that is, what node to eventually connect to, may need to be decided on. This may be a donor node in case of single hop or another already connected IAB node in case of multi-hop. The connection determination of each IAB node may form a certain topology between the IAB donor and IAB nodes that may have impact on the achievable performance of the UEs.

For different reasons, an already connected IAB node may also, potentially, have to change its connection to a different parent node.

FIG. 1 shows a reference diagram for IAB in standalone mode, which contains one IAB-donor and multiple IAB-nodes. The IAB-donor may be treated as a single logical node that may comprise a set of functions such as gNB-DU, the Control Plane function of the gNB Centralized Unit (gNB-CU-CP), the User Plane function of the gNB Centralized Unit (gNB-CU-UP) and potentially other functions. In a deployment, the IAB-donor may be split according to these functions, which may all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks.

The baseline user plane and control plane protocol stacks for IAB are shown in FIG. 2. FIG. 2 is a schematic diagram illustrating an example of a Baseline User Plane (UP) Protocol stack for IAB in rel-16. As shown in FIG. 2, the chosen protocol stacks may reuse the current CU-DU split specification in rel-15, where the full user plane F1-U, General Packet Radio System tunneling protocol user plane (GTP-U)/User Datagram Protocol (UDP)/Internet Protocol (IP), may be terminated at the IAB node, as a normal DU, and the full control plane F1-C, F1-Application Protocol (AP)/Stream Control Transmission Protocol (SCTP)/IP, may be also terminated at the IAB node, as a normal DU. In the above cases, Network Domain Security (NDS) has been employed to protect both UP and CP traffic, IPsec in the case of UP, and Datagram Transport Layer Security (DTLS) in the case of CP. IPsec may also be used for the CP protection instead of DTLS, in this case no DTLS layer may be used.

FIG. 3 is a schematic diagram illustrating a Baseline Control Plane (CP) Protocol stack for IAB in rel-16, according to existing methods.

A new protocol layer called Backhaul Adaptation Protocol (BAP) has been introduced in the IAB nodes and the IAB donor, which may be used for routing of packets to the appropriate downstream/upstream node and also mapping the UE bearer data to the proper backhaul Radio Link Controller (RLC) channel, and also between ingress and egress backhaul RLC channels in intermediate IAB nodes, to satisfy the end to end QoS requirements of bearers.

On the IAB-node, the BAP sublayer may contain one BAP entity at the MT function and a separate collocated BAP entity at the DU function as shown in FIG. 2 and FIG. 3. On the IAB-donor-DU, the BAP sublayer may contain only one BAP entity. Each BAP entity may have a transmitting part and a receiving part. The transmitting part of the BAP entity may have a corresponding receiving part of a BAP entity at the IAB-node or IAB-donor-DU across the backhaul link.

As mentioned above, 3GPP Rel-16 has introduced a new protocol layer known as Backhaul Adaptation Protocol (BAP), which may be understood to be mainly responsible for routing and bearer mapping of packets in the IAB network. More specifically, the BAP layer may be understood to be responsible for the forwarding of the packets in the intermediate nodes/hops between the IAB-donor-DU and the access IAB-node. For this purpose, the IAB-Donor-CU may assign a distinct BAP address to each IAB-node during the integration process, which may be understood to facilitate the unique identification of each IAB-node in the network. For the downstream traffic, the BAP layer of the IAB-Donor-DU may add a BAP header to packets received from the upper layer. Similarly, for the upstream traffic, the BAP layer of the access IAB-node may add a BAP header to the upper layer packets.

The transmitting part of the BAP entity on the IAB-MT may receive BAP Service Data Units (SDUs) from upper layers and BAP Data Packets from the receiving part of the BAP entity on the IAB-DU of the same IAB-node, and construct BAP Data Protocol Data Units (PDUs) as needed. The transmitting part of the BAP entity on the IAB-DU may receive BAP Data Packets from the receiving part of the BAP entity on the IAB-MT of the same IAB node, and construct BAP Data PDUs as needed. The transmitting part of the BAP entity on the IAB-donor DU may receive BAP SDUs from upper layers.

Upon receiving a BAP SDU from upper layers, the transmitting part of the BAP entity may be required to select a BAP address and a BAP path identity for this BAP SDU, and construct a BAP Data PDU by adding a BAP header to the BAP SDU, where the DESTINATION field may be set to the selected BAP address and the PATH field may be set to the selected BAP path identity.

When the BAP entity has a BAP Data PDU to transmit, the transmitting part of the BAP entity may be required to perform routing to determine the egress link, determine the egress BH Radio Link Control (RLC) channel, and submit this BAP Data PDU to the selected egress BH RLC channel of the selected egress link.

At an IAB-node, for a BAP SDU received from upper layers and to be transmitted in upstream direction, the BAP entity may perform mapping to a BAP address and BAP path identity based on Uplink Traffic to Routing IDentifier (ID) Mapping Configuration, which may be derived from information contained in F1 Application Protocol (F1AP) UE Context Management messages for user plane traffic and F1AP Interface Management messages for non-user plane traffic configured to the IAB-node.

Each entry of the Uplink Traffic to Routing ID Mapping Configuration may contain a traffic type specifier, which may be indicated by UL User Plane (UP) Transport Network Layer (TNL) Information Element (IE) for F1-U packets and Non-UP Traffic Type IE for non-F1-U packets in ref [2] TS 38.473, v. 16.4.0, and a BAP routing ID, which may include a BAP address and a BAP path identity, indicated by BAP Routing ID IE in BH information IE in ref [2] TS 38.473, v. 16.4.0.

At the IAB-node, for a BAP SDU received from upper layers and to be transmitted in upstream direction, the BAP entity may be required to perform the following. If the Uplink Traffic to Routing ID Mapping Configuration is not configured for this traffic type in accordance with TS 38.473, v. 16.4.0 or if it resolves to an egress link, which is not available; and if the defaultUL-BAP-routingID has been configured via Radio Resource Control (RRC), select the BAP address and the BAP path identity as configured by defaultUL-BAP-routingID in ref [3] TS 38.331, v. 16.3.1.

Else, for the BAP SDU encapsulating an F1-U packet, the BAP entity may be required to select an entry from the Uplink Traffic to Routing ID Mapping Configuration with its traffic type specifier corresponding to the destination IP address and Tunnel Endpoint Identifer (TEID) of this BAP SDU. For the BAP SDU encapsulating a non-F1-U packet, the BAP entity may be required to select an entry from the Uplink Traffic to Routing ID Mapping Configuration with its traffic type specifier corresponding to the traffic type of this BAP SDU. The BAP entity may be required to select the BAP address and the BAP path identity from the BAP routing ID in the entry selected above.

### BAP Routing ID Selection at IAB-Donor-DU

For a BAP SDU received from an upper layer at the IAB-donor-DU, the BAP entity may perform mapping to a BAP address and a BAP Path identity based on Downlink Traffic to Routing ID Mapping Configuration, which may be derived from IP-to-layer-2 traffic mapping Information IE configured on the IAB-donor-DU in ref [2] TS 38.473, v. 16.4.0.

Each entry of the Downlink Traffic to Routing ID Mapping Configuration may contain a destination IP address, which may be indicated by a Destination IAB TNL Address IE, an IPv6 Flow Label, if configured, which may be indicated by IPv6 Flow Label IE, a list of Differentiated Services Code Point (DSCP) values, if configured, which may be indicated by a DS Information List IE, and a BAP routing ID, which may be indicated by BAP Routing ID IE in ref [2] TS 38.473, v. 16.4.0.

At the IAB-donor-DU, for a BAP SDU received from upper layers and to be transmitted in downstream direction, the BAP entity may be required to, for the BAP SDU encapsulating an IPv6 packet, select an entry from the Downlink Traffic to Routing ID Mapping Configuration which may fulfil the following conditions. First, the Destination IP address of this BAP SDU matches the destination IP address in this entry. Second, the IPv6 Flow Label of this BAP SDU matches IPv6 flow label in this entry, if configured. And third, the DSCP of this BAP SDU matches one of the DSCP values in this entry, if configured.

For the BAP SDU encapsulating an IPv4 packet, the BAP entity may be required to select an entry from the Downlink Traffic to Routing ID Mapping Configuration which fulfils the following conditions. First, the Destination IP address of this BAP SDU matches the destination IP address in this entry. Second, the DSCP of this BAP SDU matches one of the DSCP values in this entry if configured.

The BAP entity may be required to select the BAP address and the BAP path identity from the BAP routing ID in the entry selected above.

### Routing

The BAP entity may perform routing based on the BH Routing Configuration derived from the BH ROUTING CONFIGURATION message as specified in ref [2] TS 38.473, v. 16.4.0.

Each entry of the BH Routing Configuration may contain a BAP Routing ID consisting of a BAP address and a BAP path identity, and a Next Hop BAP Address.

For a BAP Data PDU to be transmitted, BAP entity may be required to, if the BAP Data PDU corresponds to a BAP SDU received from the upper layer, and if there is no BH Routing Configuration configured in accordance with ref [2] TS 38.473, v. 16.4.0, that is, during IAB-node integration phase, or the egress link contained in the BH Routing Configurations is not available, select the egress link for which the egress BH RLC channel corresponding to defaultUL-BH-RLC-channel is configured as specified in ref [3] TS 38.331, v. 16.3.1. Else, if there is an entry in the BH Routing Configuration whose BAP address matches the DESTINATION field, whose BAP path identity is the same as the PATH field, and whose egress link corresponding to the Next Hop BAP Address is available, select the egress link corresponding to the Next Hop BAP Address of the entry.

Else, if there is at least one entry in the BH Routing Configuration whose BAP address matches the DESTINATION field, and whose egress link corresponding to the Next Hop BAP Address is available, the BAP entity may be required to select an entry from the BH Routing Configuration whose BAP address is the same as the DESTINATION field, and whose egress link corresponding to the Next Hop BAP Address is available, and select the egress link corresponding to the Next Hop BAP Address of the entry selected above.

Mapping to BH RLC Channel for BAP Data Packets from Collocated BAP Entity at IAB-Node

For a BAP Data PDU received from the collocated BAP entity, the transmitting part of the BAP entity may perform mapping to an egress BH RLC channel based on BH RLC Channel Mapping Configuration, which may be derived from BAP layer BH RLC channel Mapping Info configured on the IAB-node in TS 38.473, v. 16.4.0.

Each entry of the BH RLC Channel Mapping Configuration may contain an ingress link ID, which may be indicated by Prior-hop BAP address IE, an egress link ID, which may be indicated by Next-hop BAP address IE, an ingress BH RLC channel ID, which may be indicated by Ingress BH RLC CH ID IE and, an egress BH RLC channel ID, which may be indicated by Egress BH RLC CH ID IE.

For a BAP Data PDU received from an ingress BH RLC channel of an ingress link and for which the egress link has been selected, if there is an entry in the BH RLC Channel Mapping Configuration, whose ingress BH RLC channel ID matches the BAP Data PDU's ingress BH RLC channel, whose ingress link ID matches the BAP Data PDU's ingress link, and whose egress link ID corresponds to the selected egress link, the BAP entity may be required to select the egress BH RLC channel corresponding to egress BH RLC channel ID of this entry. Else, the BAP entity may be required to select any egress BH RLC channel on the selected egress link.

Mapping to BH RLC Channel for BAP SDUs from Upper Layers at IAB-Node

For a BAP SDU received from upper layers at the IAB-node, the BAP entity may perform mapping to an egress BH RLC channel based on a list of egress BH RLC channels, which may be contained in the BH Information IE configured via F1AP, and where each egress BH RLC channel may be specified by a Next-hop BAP address IE and an Egress RLC CH ID IE, and the egress link selected in the routing of the BAP SDU. Or the BAP entity may use the defaultUL-BH-RLC-channel.

For the BAP SDU, the BAP entity may be required to, if the BAP address and BAP path identity for this SDU has been selected from the defaultUL-BAP-routingID, select the egress BH RLC channel corresponding to defaultUL-BH-RLC-Channel configured via RRC. Else, the BAP entity may be required to select the list of BH RLC channels contained in the BH Information IE, that has been used for the selection of the BAP address and BAP path identity for this SDU, select from the list of BH RLC channels the entry whose Next-hop BAP address corresponds to the egress link selected in the routing of this SDU, and select from this list entry the BH RLC channel that corresponds to the Egress BH RLC CH ID.

Mapping to BH RLC Channel for BAP SDUs from Upper Layers at IAB-Donor-DU

For a BAP SDU received from upper layers at the IAB-donor-DU, the BAP entity may perform mapping to an egress BH RLC channel based on a list of egress BH RLC channels, which may be contained in the BH Information IE configured via F1AP, and where each egress BH RLC channel is specified by a Next-hop BAP address IE and an Egress RLC CH ID IE, and the egress link selected in the routing of the BAP SDU.

For the BAP SDU, the BAP entity may be required to select the list of BH RLC channels contained in the BH Information IE, that has been used for the selection of the BAP address and BAP path identity for this SDU, select from the list of BH RLC channels the entry whose Next-hop BAP address corresponds to the egress link selected in the routing of this SDU, and select from this list entry the BH RLC channel that corresponds to the Egress BH RLC CH ID.

Existing methods for routing traffic in a multi-hop IAB deployment may lead to waste of radio resources, increased latency, waste of processing resources, and waste of energy resources.

### SUMMARY

Current IAB architecture establishes backhaul RLC channels for forwarding end-user traffic, where intermediate IAB-nodes, e.g., IAB-node 1, IAB-node 2, etc. are mainly selected based on their radio link condition and radio resource availability to fulfil the Quality of Service (QoS) requirements of the end-user traffic.

With the increased demand for 5G deployments, and the new use cases that 5G will bring, enhancements to the telecommunication networks and infrastructures may be necessary. 5G deployments in mmWave, such as with small cell, IAB-node, street macro sites, is expected to increase rapidly to cope with the huge capacity demands. These deployed nodes will consume a lot of power. However, existing methods do not consider any operating efficiency in terms of power supply, radio power consumption and/or PSU and battery efficiency, etc. . . . for delivering the traffic by each IAB-node, which degrades the total operational efficiency of an IAB network.

It is an object of embodiments herein to improve the handling a path for a packet in a communications network.

According to a first aspect of embodiments herein, the object is achieved by a method, performed by a first node. The method may be understood to be for handling a path for a packet in a communications network. The first node operates in the communications network. The first node obtains, from another node operating in the communications network, a respective indication. The respective indication is of a respective efficiency measure of power use of a plurality of nodes operating in the communications network along at least two paths. The first node then selects a path for a first packet in the communications network, among the at least two paths. The selection is based on the obtained respective indication.

According to a second aspect of embodiments herein, the object is achieved by a method, performed by a third node. The method may be understood to be for handling a path for the packet in the communications network. The third node operates in the communications network. The third node determines, using a machine-learning model, the respective indication of the predicted respective efficiency measure of power use of the plurality of nodes. The nodes in the plurality of nodes are operating in the communications network along the at least two paths. The third node then sends, to the first node operating in the communications network, the respective indication of the determined respective efficiency measure of power use.

According to a third aspect of embodiments herein, the object is achieved by a method, performed by a second node. The method may be understood to be for handling a path for the packet in the communications network. The second node operates in the communications network. The second node sends, to the first node operating in the communications network, the respective indication of the respective efficiency measure of power use of the second node operating in the communications network along one of the at least two paths.

According to a third aspect of embodiments herein, the object is achieved by a first node. The first node may be understood to be for handling a path for a packet in a communications network. The first node is configured to operate in the communications network. The first node is configured to obtain, from another node configured to operate in the communications network, a respective indication. The respective indication is configured to be of a respective efficiency measure of power use of a plurality of nodes configured to operate in the communications network along at least two paths. The first node is further configured to select a path for a first packet in the communications network, among the at least two paths. The selection is configured to be based on the respective indication configured to be obtained.

According to a fourth aspect of embodiments herein, the object is achieved by a third node. The third node may be understood to be for handling a path for the packet in the communications network. The third node is configured to operate in the communications network. The third node is further configured to determine, using a machine-learning model, the respective indication of the predicted respective efficiency measure of power use of the plurality of nodes. The nodes in the plurality of nodes are configured to operate in the communications network along the at least two paths. The third node is further configured to then send, to the first node configured to operate in the communications network, the respective indication of the respective efficiency measure of power use configured to be determined.

According to a fifth aspect of embodiments herein, the object is achieved by a second node. The second node may be understood to be for handling a path for the packet in the communications network. The second node is configured to operate in the communications network. The second node is further configured to send, to the first node configured to operate in the communications network, the respective indication of the respective efficiency measure of power use of the second node configured to operate in the communications network along one of the at least two paths.

By the first node obtaining the respective indication of the respective efficiency measure of power use of the plurality of nodes, the first node may be enabled to select the path for the first packet in the communications network based on the obtained respective indication and then route the first packet in a more power efficient operation. The first node may be enabled to set up different radio bearer “streams” in the multi hop arrangement, select Backhaul RLC channels, or backhaul radio bearers, and paths for end-user traffic taking into account the efficiency of power use, leading to more efficient usage of energy in the communications network to route end-user traffic. Hence, usage of energy resources in the communications network may be more efficient.

By the third node determining the respective indication of the plurality of nodes, the third node is then enabled to send the respective indication to the first node. By the third node sending the respective indication to the first node, the third node enables the first node to select the path to route the first packet in a manner whereby the energy resources in the communications network are used more efficiently.

By the second node sending the respective indication of the respective measure of efficiency of power use to the first node, the second node may enable the first node to select the path for the first packet in the communications network, among the at least two paths, having the best total measure of efficiency, and thereby to transmit the first packet to be routed via the most efficient traffic path.

### BRIEF DESCRIPTION OF THE DRAWINGS

Examples of embodiments herein are described in more detail with reference to the accompanying drawings, and according to the following description.

FIG. 1 depicts a reference diagram for IAB-architectures, as shown in TR 38.874.

FIG. 2 is a schematic diagram illustrating an example of a Baseline User Plane (UP) Protocol stack for IAB in rel-16, according to existing methods.

FIG. 3 is a schematic diagram illustrating an example of a Baseline Control Plane (CP) Protocol stack for IAB in rel-16, according to existing methods.

FIG. 4 is a schematic diagram illustrating a communications network, according to embodiments herein.

FIG. 5 depicts a flowchart of a method in a first node, according to embodiments herein.

FIG. 6 depicts a flowchart of a method in a third node, according to embodiments herein.

FIG. 7 depicts a flowchart of a method in a second node, according to embodiments herein.

FIG. 8 is a schematic diagram illustrating an example of a communications network as an IAB network, according to embodiments herein.

FIG. 9 is a schematic diagram illustrating another example of a communications network as an IAB network, according to embodiments herein.

FIG. 10 is a schematic diagram illustrating another example of a user plane architecture for an IAB network.

FIG. 11 is a schematic diagram illustrating an example of functions performed by BAP entities for upstream transmission, according to embodiments herein.

FIG. 12 is a schematic diagram illustrating an example of example of the functions comprised in the second node for sending the respective indication.

FIG. 13 is a schematic diagram illustrating an example of PSU efficiency as a function of traffic load.

FIG. 14 is a schematic diagram illustrating another example of PSU load distribution in a communications network, according to embodiments herein.

FIG. 15 is a schematic diagram illustrating another example of methods, according to embodiments herein.

FIG. 16 is a schematic block diagram illustrating two non-limiting examples, a) and b), of a first node, according to embodiments herein.

FIG. 17 is a schematic block diagram illustrating two non-limiting examples, a) and b), of a third node, according to embodiments herein.

FIG. 18 is a schematic block diagram illustrating two non-limiting examples, a) and b), of a second node, according to embodiments herein.

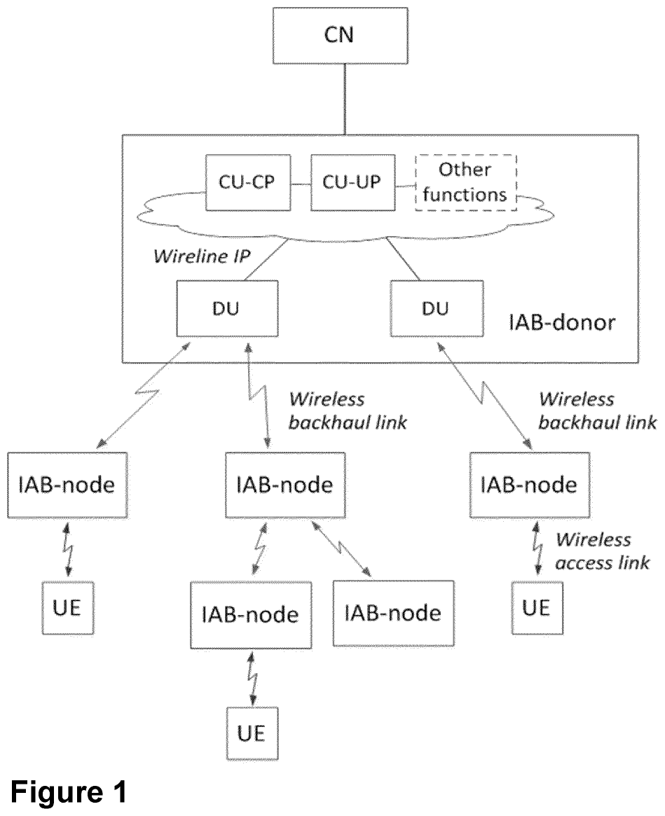

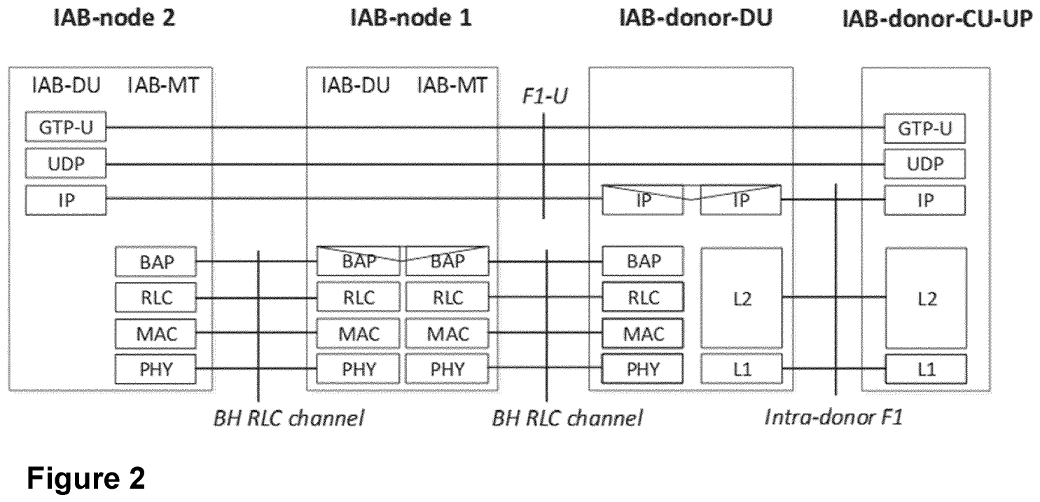

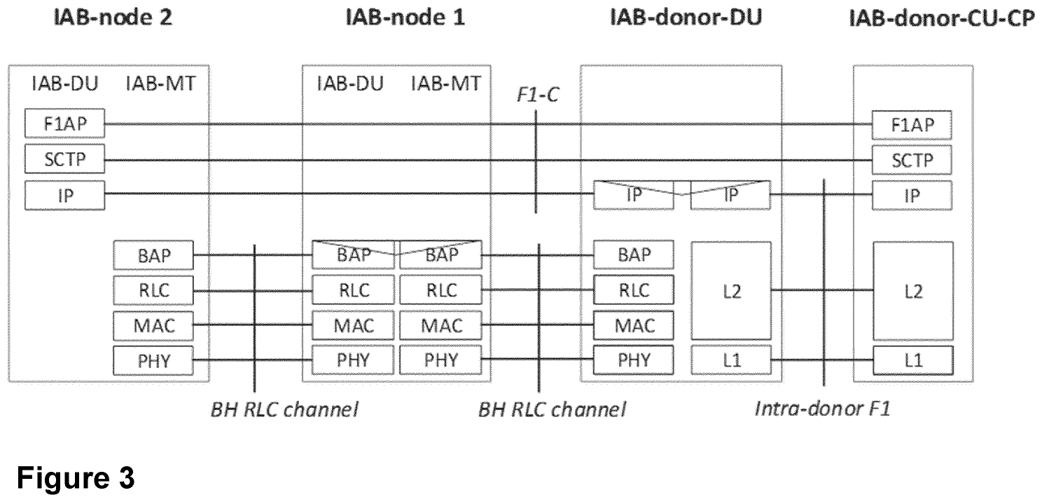

### DETAILED DESCRIPTION

Certain aspects of the present disclosure and their embodiments may provide solutions to the challenges of the existing solutions or other challenges. Embodiments herein may be understood to address the foregoing problems by considering the efficient resource utilization of the power supply or battery as a resource, feeding power to the base stations, that is, by considering the operational efficiency, for routing the end-user traffic via these small cells.

Embodiments herein may be understood to relate to a method enabling the IAB-nodes in a network to provide power supply and battery operational information to IAB-donor nodes and their parent nodes. The IAB-donor nodes and the parent nodes may then utilize this information along with other parameters such as radio link budget, amount of traffic and QoS requirements, etc. to select paths and establish BH RLC channels for end-user traffic in an IAB network. Embodiments and examples herein may be understood to provide methods and apparatus improving IAB architectural and resource efficiency.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

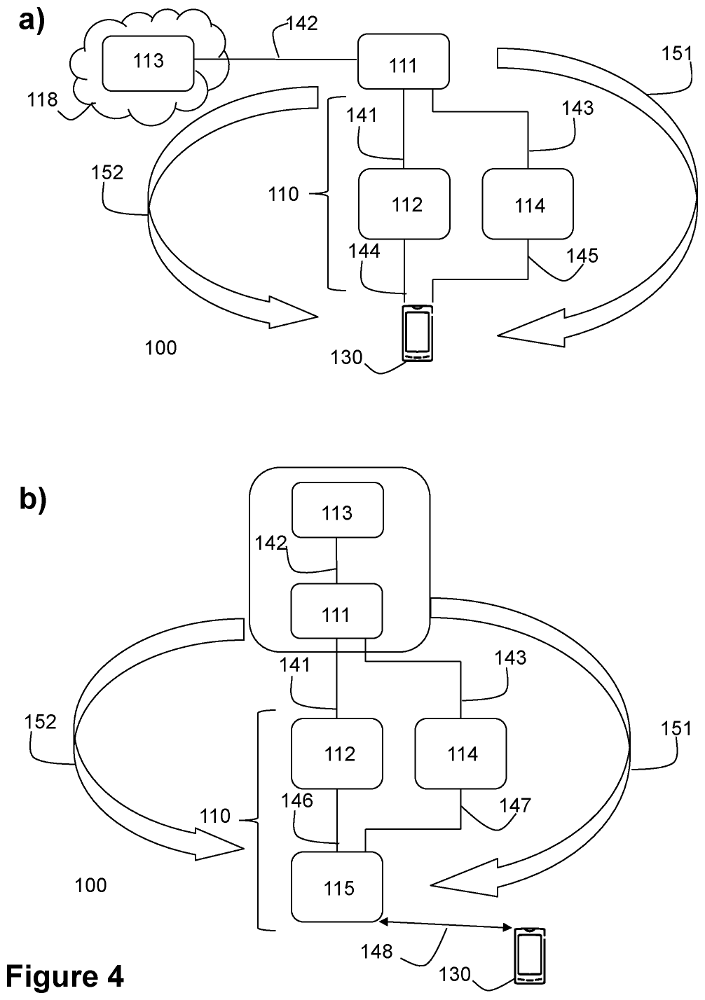

FIG. 4 depicts a non-limiting example of a communications network 100, which may be a wireless communications network, sometimes also referred to as a wireless communications system, cellular radio system, or cellular network, in which embodiments herein may be implemented. The communications network 100 may be an IAB network. Typically, the communications network 100 may be a 5G system, 5G network, NR-U or Next Gen System or network, LAA, or MulteFire. The communications network 100 may alternatively be a younger system than a 5G system. The communications network 100 may support other technologies such as, particularly, Long-Term Evolution (LTE) system, LTE-Advanced/LTE-Advanced Pro, e.g., LTE Frequency Division Duplex (FDD), LTE Time Division Duplex (TDD), LTE Half-Duplex Frequency Division Duplex (HD-FDD), and LTE operating in an unlicensed band. The communications network 100 may support yet other technologies such as, for example, License-Assisted Access (LAA), Narrow Band Internet of Things (NB-IoT), Machine Type Communication (MTC), MulteFire, Wideband Code Division Multiplexing Access (WCDMA), Universal Terrestrial Radio Access (UTRA) TDD, Global System for Mobile communications (GSM) network, Enhanced Data for GSM Evolution (EDGE) network, GSM/EDGE Radio Access Network (GERAN) network, Ultra-Mobile Broadband (UM B), network comprising of any combination of Radio Access Technologies (RATs) such as e.g., Multi-Standard Radio (MSR) base stations, multi-RAT base stations etc., any 3rd Generation Partnership Project (3GPP) cellular network, WiFi networks, Worldwide Interoperability for Microwave Access (WiMax). Thus, although terminology from 5G/NR and LTE may be used in this disclosure to exemplify embodiments herein, this should not be seen as limiting the scope of the embodiments herein to only the aforementioned systems.

The communications network 100 comprises a first node 111, and a plurality of nodes 110, whereof a second node 112 and a third node 113 are depicted in the non-limiting example of FIG. 4. Any of the second node 112 and the third node 113 may be collectively referred to as another node 112, 113. The plurality of node 110 may comprise other nodes, such as a fourth node 114, and a fifth node 115, which are depicted in FIG. 4 for illustrative purposes only. In other examples than those depicted in FIG. 4, the plurality of nodes 110 may comprise a different number of nodes. Any of the first node 111, the nodes in the plurality of nodes 110, the second node 112, the third node 113, the fourth node 114, and the fifth node 115 may be a radio network node, such as a radio base station, base station or a transmission point, or any other network node with similar features capable of serving a user equipment, such as a wireless device or a machine type communication device, in the communications network 100. For example, any of the first node 111, the nodes in the plurality of nodes 110, the second node 112, the third node 113, the fourth node 114, and the fifth node 115 may be a gNB, an eNB, an eNodeB, a Home eNode B, or a Home Node B. Any of the first node 111, the nodes in the plurality of nodes 110, the second node 112, the third node 113, the fourth node 114, and the fifth node 115 may be of different classes, such as, e.g., macro base station (BS), home BS or pico BS, based on transmission power and thereby also cell size. In some embodiments, any of the first node 111, the nodes in the plurality of nodes 110, the second node 112, the third node 113, the fourth node 114, and the fifth node 115 may be implemented as one or more distributed nodes, such as virtual nodes in the cloud, and they may perform their functions entirely on the cloud, or partially, in collaboration with one or more radio network nodes.

As depicted in the non-limiting example of FIG. 4, the communications network 100 comprises a multi-hop deployment, wherein the first node 111 may be understood as being enabled to be one or an intermediate node, e.g., a parent node to downstream node, and a donor node. The nodes in the plurality of nodes 110, may be understood as the nodes in the communications network 100, that may be located between the first node 111 and a destination node of a packet, or first packet, sent via the first node 111. The second node 112 may be understood as an intermediate node, e.g., a relay node or an IAB node, which may be a stationary relay/IAB node or a mobile relay/IAB node. The third node 113 may be one of the donor IAB node and/or another node in a cloud 118. It may be understood that the communications network 100 may comprise more nodes, which are not depicted in FIG. 4 to simplify the Figure.

The fourth node 114 may be another intermediate node, e.g., another relay node or an IAB node, which may be a stationary relay/IAB node or a mobile relay/IAB node. The fifth node 115 may be a destination node of traffic within the communications network 100.

The communications network 100 covers a geographical area which may be divided into cell areas, wherein each cell area may be served by a node, although, one node may serve one or several cells. In the non-limiting example of FIG. 4, the cells are not depicted to simplify the Figure.

The donor node in the communications network 100 has a connection, e.g., a wired backhaul connection, to a core network of the communications network 100.

A wireless device 130, or more, may be located in the wireless communication network 100. The wireless device 130, e.g., a 5G UE, may be a wireless communication device which may also be known as e.g., a UE, a mobile terminal, wireless terminal and/or mobile station, a mobile telephone, cellular telephone, or laptop with wireless capability, just to mention some further examples. The wireless device 130 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. The wireless device 130 comprised in the communications network 100 is enabled to communicate wirelessly in the communications network 100. The communication may be performed e.g., via a RAN, and possibly the one or more core networks, which may be comprised within the communications network 100.

The first node 111 may be configured to communicate in the communications network 100 with the second node 112 over a first link 141. The first node 111 may be configured to communicate in the communications network 100 with the third node 113 over a second link 142. The first node 111 may be configured to communicate in the communications network 100 with the fourth node 114 over a third link 143. The second node 113 may be configured to communicate in the communications network 100 with the wireless device 130 over a fourth link 144. The fourth node 114 may be configured to communicate in the communications network 100 with the wireless device 130 over a fifth link 145. The fifth node 115 may be configured to communicate in the communications network 100 with the second node 112 over a sixth link 146. The fourth node 114 may be configured to communicate in the communications network 100 with the fifth node 115 over a seventh link 147. The fifth node 115 may be configured to communicate in the communications network 100 with the wireless device 130 over an eighth link 148.

Each of the first link 141, the second link 142, the third link 143, the fourth link 144, the fifth link 145, the sixth link 146, the seventh link 147 and the eighth link 148 may be, e.g., a radio link.

A connection between any two given nodes in the communications network may follow one or more paths. For example, a packet may follow different paths in the communications network 100 between any two given nodes. A first path 151 may be followed from the first node 111 to a destination node, e.g., the wireless device 130, or the fifth node 115, over the fourth node 114. A second path 152 may be followed from the first node 111 to the destination node, e.g., the wireless device 130, or the fifth node 115, over the second node 112.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth”, “fifth”, . . . , “eighth”, etc. herein may be understood to be an arbitrary way to denote different elements or entities and may be understood to not confer a cumulative or chronological character to the nouns they modify, unless otherwise noted, based on context.

In this document, the terms “F1AP connection”, “F1 association”, and “F1 signalling” are used interchangeably; the terms “BAP protocol” and “BAP layer” are used interchangeably; the terms “IAB-Donor” and “IAB-Donor node” are used interchangeably; the terms “backhaul RLC channel” and “BH RLC channel” and “BH bearer”, and “BH Radio bearer” are used interchangeably.

The use of the new 3GPP defined, IAB architecture and control functionality for establishing BH RLC channels and selecting BH RLC links, for routing end-user traffic, has been standardized in e.g., Rel-16 3GPP TS 38.340, v. 16.3.0. Furthermore, Rel-17 work item includes “IAB Enhancement”, 3GPP RP-201293, “Enhancements to Integrated Access and Backhaul for NR”, which may add new optional features for IAB to optimize it performance.

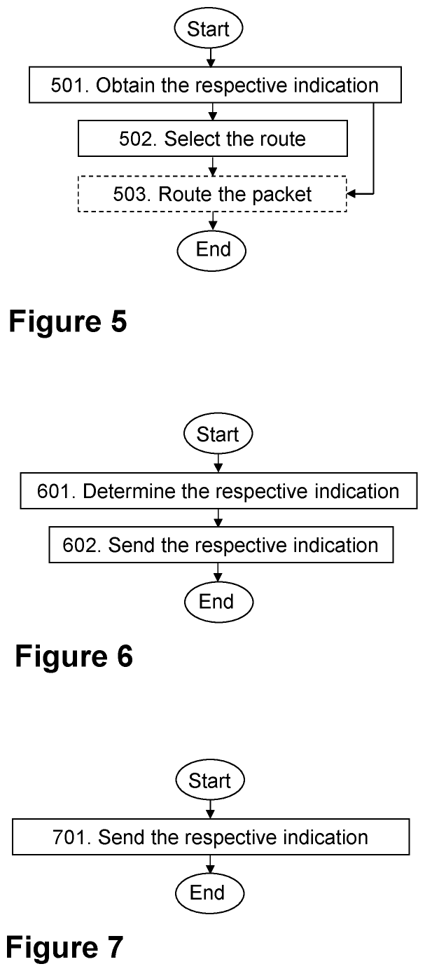

Embodiments of a computer-implemented method, performed by the first node 111, will now be described with reference to the flowchart depicted in FIG. 5. The method may be understood to be for handling a path for a first packet in the communications network 100. The first node 111 operates in the communications network 100. The communications network 100 may be a multi-hop deployment. In some embodiments, the communications network 100 may be an IAB network.

Several embodiments are comprised herein. In some embodiments all the actions may be performed. In other embodiments, two or more actions may be performed. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. Some actions may be performed in a different order than that shown in FIG. 5. In FIG. 5, actions which may be optional in some examples are depicted with dashed boxes.

Action 501

In the course of operations of the communications network 100, the first node 111 may receive a first packet, referred to herein simply as packet, that it may need to forward to a destination node, such as the wireless device 130 or the fifth node 115. For illustration purposes only, there may be two paths between the first node 111 and the destination node: the first path 151 and the second path 152. The communications network 100 may have different deployments, and it may be understood that the examples depicted in FIG. 4 are non-limiting.

Once the first node 111 obtains the first packet, it may therefore need to decide a path to deliver the first packet to its destination.

In order to later enable the first node 111 to choose the path the first packet may need to follow to reach its destination, according to embodiments herein, the first node 111 may consider how efficiently the nodes along the at least two paths 151, 152 may make use of power. According to the foregoing, in this Action 501, the first node 111 may obtain, from another node 112, 113 operating in the communications network 100, a respective indication of a respective measure of efficiency of power use of the plurality of nodes 110 operating in the communications network 100 along the at least two paths 151, 152. That is, the first node may obtain the respective indication for at least each of the nodes comprised in the different paths 151, 152 it may need to later choose from to route the first packet to its destination.

As stated earlier, the another node 112, 113 may be the second node 112, or the third node 113, and this corresponds to the two different ways in which the first node 111 may obtain the respective indication. In some examples, the first node 111 may itself receive directly the respective indication from each of the nodes in the plurality of nodes 110, in which case, for example, the second node 112 may be considered to be any of the nodes in the plurality of nodes 110. In such examples, the obtaining in this Action 501, e.g., receiving, may be performed, e.g., via the first link 141.

In other examples, a different node, e.g., the third node 113, may collect the respective indications from each of the nodes in the plurality of nodes 110, and the third node 113 may then provide the respective indications to the first node 111. In such examples, the obtaining in this Action 501, e.g., receiving, may be performed, e.g., via the second link 142.

That the indication is a respective indication may be understood as that each of the nodes in the plurality of nodes 110 may provide their own indication. For example, the efficiency information of each of the nodes in the plurality of nodes 110, may be incorporated inside the BAP protocol as feedback to the IAB donor. In some embodiments, the first node 111 may be one of a donor IAB node and an intermediate IAB node. The third node 113 may be one of the donor IAB node and another node in the cloud 118. That is, in some examples, the first node 111 may be the same node as the third node 113.

In another example, the first node 111 and its power supply unit, and the nodes in the plurality of nodes 110 may report the efficiency to the base band function. In yet another example, the functionality inside the base band function may then report the efficiency of all the nodes in the plurality of nodes 110, to the IAB donor, that is, the first node 111.

What May be Indicated by the Respective Measure of Efficiency

The respective measure of efficiency of power use may comprise a first measure of efficiency of a Power Supply Unit (PSU) of a respective node of the plurality of nodes 110 and a second measure of efficiency of a battery unit of the respective node of the plurality of nodes 110.

The first measure of efficiency of a PSU may be measured as efficiency=Power output/Power input, or η=Pout/Pin.

The second measure of efficiency of a battery unit may be measured as Watt hours output/Watt hour input or (Wh out)/(Wh in).

The PSU as apparatus, may have inbuilt functionality to report the respective efficiency, for better utilization of recourses. The PSU and battery efficiency may then be obtained from each node in the plurality of nodes 110 to the first node 111, which in some embodiments may be the IAB donor. The information may be included inside a grid matrix, that is, a time x frequency grid of subframes that may be used in e.g., LTE and NR, as symbol information into the BAP structure.

In some embodiments, the respective indication may further indicate a respective third measure of efficiency of radio resources of the respective node of the plurality of nodes 110. That is, when each node in the plurality of nodes 110 may report its respective efficiency, it may additionally report the efficiency based on the radio traffic, as spectral efficiency, total radio consumption, as well as incorporated PSU and battery efficiency.

In some embodiments, the respective indication may be an observed respective measure of efficiency of power use obtained from the respective nodes in the plurality of nodes 110. In such embodiments, the another node may be the second node 112. That is, in these embodiments, each of the nodes in the plurality of nodes 110 may calculate its own measure of efficiency, and may then provide this real or observed measurement, to the first node 111.

In other embodiments, the operational, observed, information may be used to train a machine learning (ML) model for predicting the respective measures of efficiency of power use, e.g., the PSU efficiency. That is, in other embodiments, the respective indication may be a predicted respective measure of efficiency of power use obtained via a ML model to predict the respective measure of efficiency of power use of the plurality of nodes 110. In such embodiments, the another node may be the third node 113. That is, the third node 113 may collect the observed respective measures of efficiency, train and run a ML model, to predict the respective measures, and the predicted respective measures may then be obtained from the third node 113 by the first node 111 in this Action 501.

In these embodiments, the nodes in the plurality of nodes 110 may send their observed respective measures of efficiency of power use to the third node 113, e.g., an Operations and Management node (OAM), or another centralized entity in the communications network 100, for training a ML/Artificial Intelligence (AI) algorithm, in another packet or second packet. In this case, IAB-donor DU after receiving the second packet, containing the respective indication, may change the BAP header and may forward the second packet to the destination entity via the IP routing functionality supported by the IAB-Donor-DU. For downstream traffic, the BAP layer of a IAB-donor-DU, e.g., the first node 111, may add a BAP header to each packet, which may then be removed by the BAP layer of the destination IAB-DU before forwarding the packet to the upper layers such as GTP/IP, etc. Similarly, for the upstream traffic, the BAP layer of the source IAB-node DU may add the BAP header to each packet, which may then be removed by the IAB-Donor-DU.

In other embodiments, the respective indication may be an alarm with respect to one of the observed respective measure of efficiency and the predicted respective measure of efficiency. That is, alarm information may be sent as status information and the condition of the PSU and the battery may be mapped as symbol structures in the resource grid of time x frequency, inside the BAP protocol payload for multi-hop arrangement. For example, an alarm may be a hardware fault alarm on PSU, battery, radio etc.

How to Obtain the Respective Indication

As to how the first node 111 may obtain the respective indication, in some embodiments, the respective indication may be comprised in a non-F1-U packet. In these embodiments, the nodes in the plurality of nodes 110 may employ the non-F1-U packets to communicate the respective indication comprising the operational information, of radio, PSU battery operational efficiency to the first node 111, or the node collecting this information, e.g., the third node 113 in some embodiments.

In some examples, the DU functionality of each of the nodes in the plurality of nodes 110, e.g., the second node 112, that is, the IAB-node DU functionality, may map these non-F1-U second packets, carrying the respective indication, to specific Backhaul Radio Link Control (BH RLC) channels in the mapping tables that may have been configured by the IAB-donor via F1/RRC signalling. A mapping table may be understood as, e.g., an association between traffic IP address(es) and assigned BAP Routing ID. and may have the function of assigning the appropriate egress BH link and BH RLC channel based on the mapped BAP Routing ID.

In some embodiments, the first node 111 may be an IAB-donor. In such embodiments, the DU functionality of the respective node of the plurality of nodes 110, e.g., the second node, may add a BAP header that may include the BAP Routing ID of the destined first node 111, e.g., the IAB-donor, and may push the second packets to the lower layer, the RLC layer of the MT functionality of the second node 112, as a BAP PDU. In case there is more than one uplink link toward the first node 111, the non-F1-U packets carrying the respective indication may be forwarded on the link configured by the first node 111. Any of the nodes in the plurality of nodes 110 may acquire the format for reporting the information, that is, the format that may be understandable or decodable by both the source and destination of the message, as BAP layer payload either via the third node 113, e.g., an OAM, or the IAB-donor during the integration phase of the respective node of the plurality of nodes 110 with the communications network 100.

In some particular embodiments, any of the nodes in the communications network 100 may have a capability to make local decisions in terms of routing of first packets. In such a network, the downstream nodes in the plurality of nodes 110 may send their respective indication to their respective parent nodes, e.g., the first node 111. In some examples, a downstream node may employ the non-F1-U packets for communicating this information, as has just been described for sending the respective indication to the IAB donor node. However, the difference here is that the BAP header attached to these second packets may carry the BAP Routing ID of the parent IAB-nodes, instead of the BAP Routing ID of the IAB-donor. In these embodiments, the first node 111 may be a parent node, e.g., an intermediate node.

In other examples, the BAP control PDU may be used to communicate such respective indication to the first node 111, e.g., a parent or uplink IAB-node. Rel-16 IAB-nodes support usage of BAP control PDU for sending flow control and backhaul Radio link failure information to parent and child IAB-nodes, respectively. These control PDU types may be extended for transferring the operational information to the parent IAB-nodes.

To provide some details on how the PSU and battery efficiency information may be mapped and communicated to the first node 111 as IAB-donor node, it may be understood that there may be an F1-U connection between the user plane of the first node 111 IAB-donor-CU, and the DU part of the second node 112, that is any of the nodes in the plurality of nodes 110.

The PSU efficiency information may, in some particular examples, use the GTP-U/UDP/IP stack at the DU functionality of the second node 112, that is, it may be higher layer traffic for the GTP-U/UDP/IP protocol stack of the F1-U interface, and then, the second node 112 may forward the second packet to the BAP entity at the IAB-MT of the second node 112. That is, a special F1-U message may be used for PSU efficiency information, in the sense that GTP-U tunnel ID and IP addresses may be dedicated for this purpose. Using the GTP-U tunnel ID and/or IP address of the second packet, the IAB-DU BAP entity of the second node 112 may check the mapping table, that may have been configured by the IAB-donor-CU, to select the correct uplink BH RLC channels and outgoing backhaul link. The purpose of the mapping table may be understood to be to create association between the GTP-U tunnel ID, and/or IP address, and egress BH RLC Channel for the traffic. Therefore, the traffic with a given GTP-U ID may be assigned a specific BH RLC channel using the mapping table. After that, the BAP layer of the second node 112 may add a BAP header that may include the BAP Routing ID of the destination, here, the first node 111, e.g., the IAB-donor node, and may forward the BAP PDU to the lower layer, that is, the RLC layer. Depending on the importance of the respective indication, the IAB-donor may set a proper value, that is, a high or low priority BH RLC channel via a BH RLC CH QoS IE value, and the BH RLC channel may be either 1:1 or N:1 mapped. Note that 1:1 may be understood to correspond to a dedicated BH RLC channel used for high priority traffic, whereas N:1 may be understood to correspond to a shared BH RLC channel with other traffic and may be understood to be mostly used for low priority traffic backhaul RLC channel. Also, a different priority may be assigned to a BH RLC channel by utilizing the BH RLC CH Quality of Service (QoS) Information Element (IE).

When the DU of the first node 111 may receive this traffic, the BAP layer of the DU of the first node 111 may strip off the BAP header and may forward the second packet to the CU of the first node 111. From the GTP-U tunnel ID, the CU of the first node 111 may know that that the second packet and/or traffic may carry the PSU/battery efficiency information from the another node 112, 113 and may then store and/or save information for traffic routing and BH RLC channel mapping to the respective node.

According to any of the different foregoing scenarios, in some embodiments, the respective indication may be comprised in a second packet comprising a BAP header. The header may comprise a BAP routing ID of parent nodes in the selected path.

Efficiency information, PSU, battery, of each relay nodes, may be included in the information symbol structure, e.g., in the time x frequency grid of the subframe structure of LTE or NR, back to the first node 111, inside the symbols.

When to Obtain the Respective Indication

Another alternative may be that the first node 111 may send a polling message or third packet, using non-F1-U traffic, asking the nodes in the plurality of nodes 110 to send the respective indication, and the nodes in the plurality of nodes 110 may then acknowledge this by providing the information.

In yet other embodiments, the obtaining 501 may be performed based on at least one of: a) a periodicity, and b) a change in the respective measure of efficiency exceeding a threshold. According to the first option, the another node 112, 113 may communicate the respective indication to the first node 111 after a specific time interval, which may be configured by the first node 111. According to the second option, the another node 112, 113 may communicate the respective indication to the first node 111 when the a change in the respective indication, e.g., the PSU or battery efficiency status and/or level may exceed a pre-defined or specific level.

The bearer set-up information for the paths—the first path 151 and the second path 152 may be set on the first node 111, in embodiments wherein the first node 111 may be a donor, and may include information of each relay node efficiency including radio, PSU efficiency and battery operation, efficiency, before setting up the radio bearer and paths. The efficiency on the battery may only be measured when a power outage may occur. Currently, the radio bearer set up in not considering this factor.

Information on efficiency from the relay nodes, may be obtained by the first node 111, before setting up the separation of radio bearer, and transition, of the streams or paths.

Embodiments herein may be understood to enable a radio bearer set-up method, based on radio and/or PSU and battery operation efficiency of the different multi-hop paths and/or streams, or functionality such as multi-hop forwarding.

By obtaining the respective indication in this Action 501, the information that may be obtained by the first node 111, e.g., as donor base station, about the different operational efficiencies of the nodes in the multi-hop arrangement, may then enable the first node 111 to use this information to set up a more “power efficient” operation for different radio bearer “streams” in the multi hop arrangement. Building on the existing standard for IAB Rel-16, new methods are provided herein to enable to use the BAP layer for communicating the operational and other architectural related information on the apparatus to set-up or select Backhaul RLC channels, or backhaul radio bearer, and routes for end-user traffic, leading to efficient energy path for end-user traffic.

Action 502

The first node 111, after obtaining the respective indication for all the nodes in the plurality of nodes 110, may use the respective indication for routing the first packet, in the communications network 100, in the event that there may be different multi-hop routings, for establishing new BH RLC channels on the intermediate links for new end-user traffic, or for performing load balancing in the communications network 100, where traffic for some of the end-user may be remapped and/or rerouted to other alternative BH bearers and/or paths to optimize the performance of the communications network 100.

In this Action 502, the first node 111 may select a path for the first packet in the communications network 100, among the at least two paths 151, 152, based on the obtained respective indication.

Selecting in this Action 502 may comprise comparing the respective indications of the different child nodes of the first node 111, comprised in the each of the at least two paths 151, 152.

For instance, to make a decision, e.g., a local decision in the event that the first node 111 is an intermediate node, of whether to forward the traffic for the wireless device 130 via the first path 151 or via the second path 152, the first node 111 may first consider the operational efficiency for its child nodes for optimal performance. That is, the first node 111 may consider the respective indication of the second node 112, and of the fourth node 114.

In further particular examples, selecting in this Action 502 may comprise comparing the respective indications of all the child nodes comprised within each of the at least two paths 151, 152. For example, the efficiency of all connected IAB nodes may be incorporated as a decision to select forwarding paths in the BAP protocol, to enable a total operation efficiency along the BAP path for an efficient operation. The first node 111 may then select the path of the at least two paths 151, 152 having the best total measure of efficiency. That is, the selecting in this Action 502, the computation may be made to set the multi-hop forwarding efficiencies for the different paths. The processing itself may comprise the mapping correlation of vector in the different routing scenarios of the at least two paths 151, 152, to transmit the packet to be routed via the most efficient traffic path.

The selecting in this Action 502, may also comprise computing the most correct radio bearer set-up into the decision channels in the first node 111, e.g., an intermediate node, with satisfaction of end to end QoS requirements of bearers along the different paths of the first path 151, and the second path 152. The most correct radio bearer may be incorporated in the BAP protocol. The most efficient may be understood here as the most power radio bearer efficient.

By selecting the path for the first packet in the communications network based on the obtained respective indication, the first node 111 may then be enabled to route the first packet in a more power efficient operation, as described in the next Action 503.

Action 503

Once the first node 111 may have selected the path to route the first packet, in this Action 503, the first node 111 may first route the first packet via the selected path by mapping bearer data to a backhaul RLC channel.

The respective measure of efficiency of power use, e.g., the first measure of efficiency of the PSU, the second measure of efficiency of the battery unit and/or the respective third measure of efficiency of the radio resources of the respective node of the plurality of nodes 110 may be included in the routing decision mechanism, setting up the radio bearers.

Within the protocol stacks inside the protocol layer called Backhaul Adaptation Protocol (BAP), the efficiency aspect of every node of the plurality of nodes 110 may be introduced. This may be used for routing of first packets to the appropriate downstream and/or upstream node, and may also incorporate mapping of the UE bearer data, that is, of the UL and/or DL data to/from the wireless device 130, to the proper backhaul RLC channel to satisfy the end to end QoS requirements of bearers, and may include the bearer efficiency of it. Particularly, according this Action 503, the DU of the first node 111 may route the first packet carrying the information to the mapped, e.g., in the subframes, in the mapping table of the BAP layer of the first node 111, destination IP address, which may be an OAM or another entity.

As explained above, in another embodiment, the first node 111 may consider using ML for the establishment of the operational efficiencies of the respective nodes of the plurality of nodes 110, including the PSU efficiency, the battery efficiency and the radio efficiency obtained by the first node 111, and include them in the decision mechanism for the first node 111 for the establishment of radio bearers in the multi-hop arrangement. That is, the first node 111 may use ML to establish the bearers with the efficiency.

The different nodes in the plurality of nodes 110, may have different loads of their respective PSUs. The load of the respective PSUs may have an important impact on the efficiency of the respective node. By routing the first packet via the selected path in this Action 503, considering operation efficiency, and moving the load to a path thereby increasing its load, it may be possible gain efficiency in the communications network 100. By selecting the right load of the nodes in the plurality of nodes 110 via the first node 111, e.g., the donor, different paths may be selected, and different actuation, that is, path selection, may be made from the first node 111, e.g., the IAB donor, selecting the paths.

The embodiments herein may be understood to allow the first node 111, based on information sent via the BAP protocol to select, not only the efficient radio bearers, but also the efficient PSU in conjunction to the radio bearers, improving the nodes total efficiency of the resources of the communications network 100 to route first packets through it.

The above embodiments may be understood to be applicable to centralized controlled IAB networks, such as a Rel-16 IAB network, where the first node 111 may be an IAB-donor which may be responsible for configuring the routing and the BH RLC channels for all the end-user traffic. However, for networks where the intermediate IAB-nodes may make local decisions about traffic forwarding, the intermediate IAB-nodes may also have the respective indication of all the downstream IAB-nodes.

Accordingly, the first node 111 may be one of a donor IAB node and an intermediate IAB node.

Embodiments of a computer-implemented method, performed by the third node 113, will now be described with reference to the flowchart depicted in FIG. 6. The method may be understood to be for handling a path for a first packet in the communications network 100. The third node 113 operates in the communications network 100. The communications network 100 may be a multi-hop deployment. In some embodiments, the communications network 100 may be an IAB network.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. The detailed description of some of the following corresponds to the same references provided above, in relation to the actions described for the first node 111 and will thus not be repeated here to simplify the description. For example, the third node 113 may be one of the donor IAB node and another node in the cloud 118.

Action 601

In this Action 601, the third node 113 determines, using a ML model, the respective indication of the predicted respective measure of efficiency of power use of the plurality of nodes 110 operating in the communications network 100 along the at least two paths 151, 152.

Determining may be understood as calculating or deriving.

The respective measure of efficiency of power use may comprise the first measure of efficiency of the power supply unit of the respective node of the plurality of nodes 110 and the second measure of efficiency of the battery unit of the respective node of the plurality of nodes.

In some embodiments, the respective indication may further indicate the predicted respective third measure of efficiency of radio resources of the respective node of the plurality of nodes 110.

In some embodiments, the respective indication may be the alarm with respect to one of the observed respective measure of efficiency and the predicted respective measure of efficiency.

The third node 113 may use for the determining in this Action 601, for example, a feed-forward neural network to collect radio efficiency, PSU efficiency and battery efficiency, including a training sequence, that may use historical data, to evaluate the best performing route and propose selection of routes for the IAB Donor.

A feed-forward neural network may be understood as an artificial neural network where connections between the nodes may not form a cycle. In embodiments herein, a multi-layer perception network may be considered for the different plurality of nodes 110, where the inputs may be fed directly to the outputs via a series of weights. The sum of the products of the weights and the inputs may be calculated in each node, and its values and gradient may be above some threshold the best performing weight for each IAB node reported to IAB donor. That is, the ML model may be understood to produce different output layers, where each output layer may correspond to a weight of importance on the efficiency and paths of each radio bearer.

Other ML method may also be used, depending on the processing capability of the third node 113.

By the third node 113 determining the respective indication of the plurality of nodes 110, the third node 113 is then enabled to send the respective indication to the first node 111, and thereby enable the first node 111 to select the path to route the first packet in a manner whereby the energy resources in the communications network are used more efficiently.

Action 602

In this Action 602, the third node 113 sends, to the first node 111 operating in the communications network 100, the respective indication of the determined respective measure of efficiency of power use.

The sending in this Action 602, may be implemented via the second link 142.

The sending in this Action 602 may be performed using the mechanisms that were explained in detail in relation to Action 501, and while they will not be repeated here, they may be understood to equally apply.

In some embodiments, the sending in this Action 602 may be performed based on at least one of: the periodicity, and the change in the respective measure of efficiency exceeding the threshold.

The first node 111 may be one of a donor IAB node and an intermediate IAB node, and the third node 113 may be one of the donor IAB node and another node in the cloud 118.

By the third node 113 sending the respective indication to the first node 111, the third node 113 enables the first node 111 to select the path to route the first packet in a manner whereby the energy resources in the communications network are used more efficiently.

Embodiments of a computer-implemented method, performed by the second node 112, will now be described with reference to the flowchart depicted in FIG. 7. The method may be understood to be for handling a path for a first packet in the communications network 100. The third node 113 operates in the communications network 100. The communications network 100 may be a multi-hop deployment. In some embodiments, the communications network 100 may be an IAB network.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. The detailed description of some of the following corresponds to the same references provided above, in relation to the actions described for the first node 111 and will thus not be repeated here to simplify the description. For example, in some embodiments, the first node 111 may be one of a donor IAB node and an intermediate IAB node, and the second node 112 may be an intermediate IAB node.

Action 701

In this Action 701, the second node 112 sends, to the first node 111 operating in the communications network 100, the respective indication of the respective measure of efficiency of power use of the second node 112 operating in a communications network 100 along one of at least two paths 151, 152.

The respective measure of efficiency of power use may comprise at least one of: the first measure of efficiency of the power supply unit of the second node 112 and the second measure of efficiency of the battery unit of the second node 112.

In some embodiments, the respective indication may further indicate the respective third measure of efficiency of the radio resources of the second node 112.

The respective indication may be an observed respective measure of efficiency of power use obtained from the second node 112.

In some embodiments, the respective indication may be comprised in the second packet comprising a Backhaul Adaptation Protocol (BAP) header. The header may comprise the BAP routing ID of the parent nodes in the path of the at least two paths 151, 152.

The indication may be comprised in a non-F1-U packet.

As described earlier, the sending in this Action 701 may be performed based on at least one of: the periodicity, and the change in the respective measure of efficiency exceeding the threshold.

The sending in this Action 701 may be performed using the mechanisms that were explained in detail in relation to Action 501, and while they will not be repeated here, they may be understood to equally apply.

By sending the respective indication of the respective measure of efficiency of power use to the first node 111 in this Action 701, the second node 112 may enable the first node 111 to select the path for the first packet in the communications network 100, among the at least two paths 151, 152, having the best total measure of efficiency, and thereby to transmit the first packet to be routed via the most efficient traffic path.

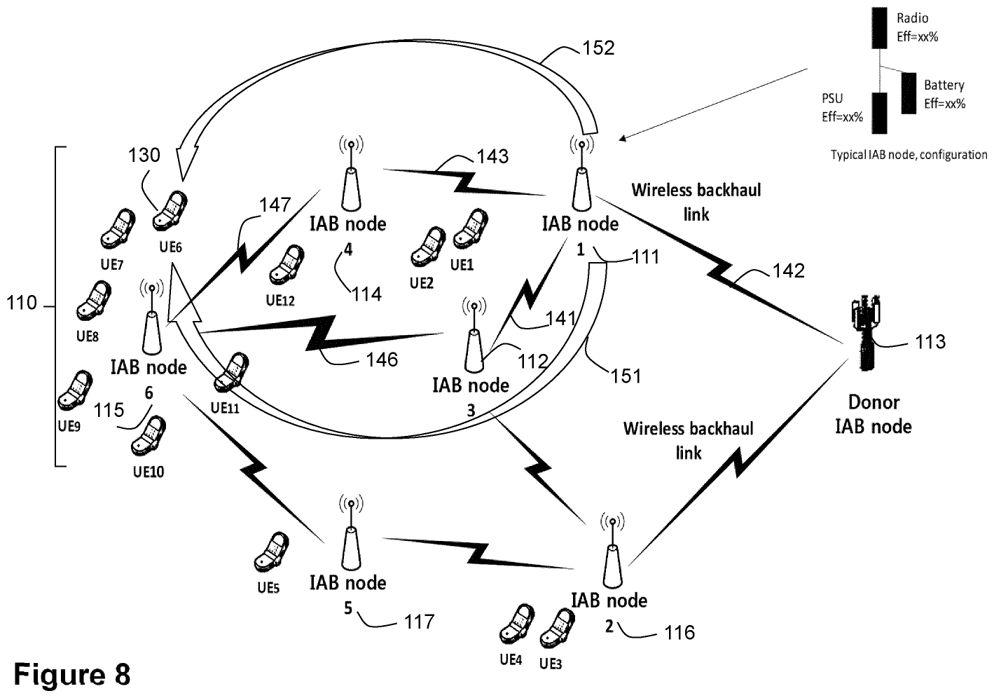

FIG. 8 is a schematic diagram illustrating a non-limiting example of the communications network 100 as an IAB network comprising the first node 111. In this non-limiting example, the third node 113 is the donor IAB node. The communications network 100 comprises the first node 111, IAB node 1, the second node 112, IAB node 3, the fourth node 114, IAB node 4, the fifth node 115, IAB node 6, the sixth node 116, IAB node 2, and a seventh node 117, IAB node 5. A plurality of wireless devices is comprised in the communications network 100, served by different nodes: UE1 and UE2 are served by the first node 111, UE3 and UE4 are served by the sixth node 116, UE5 is served by the seventh node 117, UE6, UE7, UE8, UE9, UE10 and UE11 are served by the fifth node 115, UE12 is served by the fourth node 114. The first node 111 obtains the first packet that is to be delivered to a destination, in this case, the wireless device 130 served by a fifth node 115, IAB node 6. For illustrative purposes, in this example, the wireless device 130 corresponds to UE 6. In this example, the first node 111, IAB-node-1 is allowed to make a local decision on whether to forward the traffic for the wireless device 130 via one of at least two paths. The first path 151 is via the fourth node 114 and the fifth node 115, the second path 152 is via the second node 112 and the fifth node 115. The first node 111 may then need to consider the operational efficiency for these two of its child nodes for optimal performance, according to Action 502 and Action 503. For that purpose, according to Action 501, the first node 111 may obtain, for at least each of the nodes in the plurality of nodes 110, in this example, the second node 112, the fourth node 114 and the fifth node 115, their respective indication. Alternatively, the first node 111 may obtain their respective indication from the third node 113. As schematically represented in FIG. 8, the first node 111 may obtain the first measure of efficiency of the power supply unit of the respective nodes of the plurality of nodes 110, the second measure of efficiency of the battery unit of the respective nodes of the plurality of nodes 110, and the respective third measure of efficiency of radio resources of the respective node of the plurality of nodes 110.

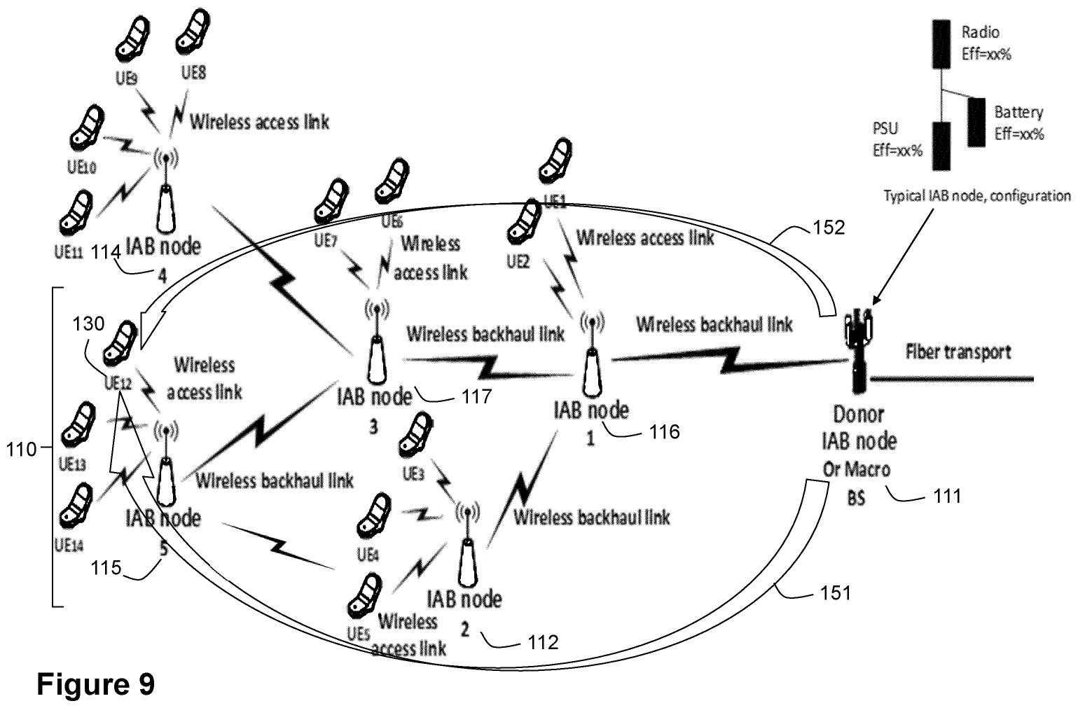

FIG. 9 is a schematic diagram illustrating another non-limiting example of the communications network 100 as an IAB network comprising the first node 111. In this non-limiting example, the first node 111 is the donor IAB node. The communications network 100 further comprises the sixth node 116, IAB node 1, the second node 112, IAB node 2, the seventh node 117, IAB node 3, the fourth node 114, IAB node 4, and the fifth node 115, IAB node 5. A plurality of wireless devices is comprised in the communications network 100, served by different nodes: UE1 and UE2 are served by the sixth node 116, UE3, UA4 and UE5 are served by the second node 112, UE6 and UE7 are served by the seventh node 117, UE8, UE9, UE10 and UE11 are served by the fourth node 114, UE12, UE13 and UE14 are served by the fifth node 115. The first node 111 obtains the first packet that is to be delivered to a destination, in this case, the wireless device 130 served by a fifth node 115, IAB node 5. For illustrative purposes, in this example, the wireless device 130 corresponds to UE12. In this example, the first node 111 makes a decision on whether to forward the traffic for the wireless device 130 via one of at least two paths. The first path 151 is via the sixth node 116, the seventh node 117 and the fifth node 115, the second path 152 is via the sixth node 116, the second node 112 and the fifth node 115. The first node 111 may then need to consider the operational efficiency for these two of its child nodes for optimal performance, according to Action 502 and Action 503. For that purpose, according to Action 501, the first node 111 may obtain, for at least each of the nodes in the plurality of nodes 110, in this example, the sixth node 116, the second node 112, the seventh node 117 and the fifth node 115, their respective indication. Alternatively, the first node 111 may obtain their respective indication from the third node 113, which is not represented in this Figure, and which may be a node in the cloud 118. As schematically represented in FIG. 9, the first node 111 may obtain the first measure of efficiency of the power supply unit of the respective nodes of the plurality of nodes 110, the second measure of efficiency of the battery unit of the respective nodes of the plurality of nodes 110, and the respective third measure of efficiency of radio resources of the respective node of the plurality of nodes 110.

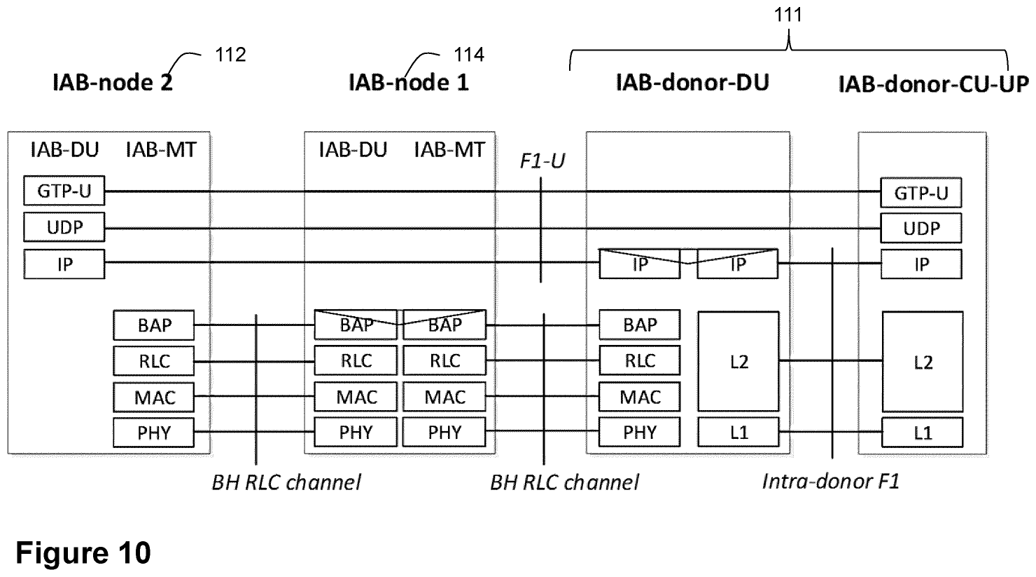

To provide some details on how the PSU and battery efficiency information may be mapped and communicated to the first node 111 as IAB-donor node, FIG. 10 is a schematic diagram illustrating a non-limiting example of a user plane architecture for the communications network 100 as an IAB network comprising the first node 111 as donor node, the second node 112 as IAB-node 2, and the fourth node 114, IAB-node 1, as intermediate node between the two nodes. Each of the second node 112 and the fourth node 114 have an IAB-DU part, and an IAB-MT part, each with its own protocol stacks. The BH RLC Channel may comprise a BAP, RLC, MAC and PHY protocol stack in each of the second node 112, the fourth node 114, and the IAB-donor DU part of the first node 111. The IAB-Donor DU and the IAB-donor CU-UP of the first node 111 may be connected via an intra-donor F1 connection between Layer 1 (L1) and Layer 2 (L2) protocol stacks. It may be seen in FIG. 10 that there is an F1-U connection between the user plane of the IAB-donor-CU and the DU part of the second node 112, IAB-node-2. As mentioned earlier, in some examples, the PSU efficiency information may use the GTP-U/UDP/IP stack at the DU functionality of the IAB-node-2, that is, it may be higher layer traffic for the GTP-U/UDP/IP protocol stack of the F1-U interface, and then the second node 112 may forward the second packet comprising the respective indication to the BAP entity at the IAB-MT, as shown in FIG. 10. Using the GTP-U tunnel ID and/or IP address of the second packet, the IAB-DU BAP entity may check the mapping table, that may have been configured by the IAB-donor-CU, to select the correct uplink BH RLC channels and outgoing backhaul link. After that, the BAP layer may add a BAP header that may include the BAP Routing ID of the destination first node 111, e.g., the IAB-donor node, and the first node 111 may forward the BAP PDU to the lower layer, that is, the RLC layer. Depending on the importance of the PSU/battery efficiency information, the IAB-donor may set a proper value, that is, a high or low priority BH RLC channel via BH RLC CH QoS Information Element (1E) value, and either 1:1 or N:1 mapped BH RLC channel. As noted earlier, 1:1 may be understood to correspond to a dedicated BH RLC channel used for high priority traffic, whereas N:1 may be understood to correspond to sharing a BH RLC channel with other traffic. The priority information relating to the paths may be shared by the donor node to other children IAB nodes. The N:1 mapping may be understood to be mostly used for low priority traffic backhaul RLC channel. Also, a different priority may be assigned to a BH RLC channel by utilizing the BH RLC CH QoS IE. When the IAB-donor-DU may receive this traffic, the BAP layer of the donor-DU may strip off the BAP header and may forward the second packet to the IAB-donor-CU. From the GTP-U tunnel ID, the donor-CU may know that that the packet/traffic may carry the PSU/battery efficiency information from the second node 112, and may then store and/or save information for traffic routing and BH RLC channel mapping to the respective node.

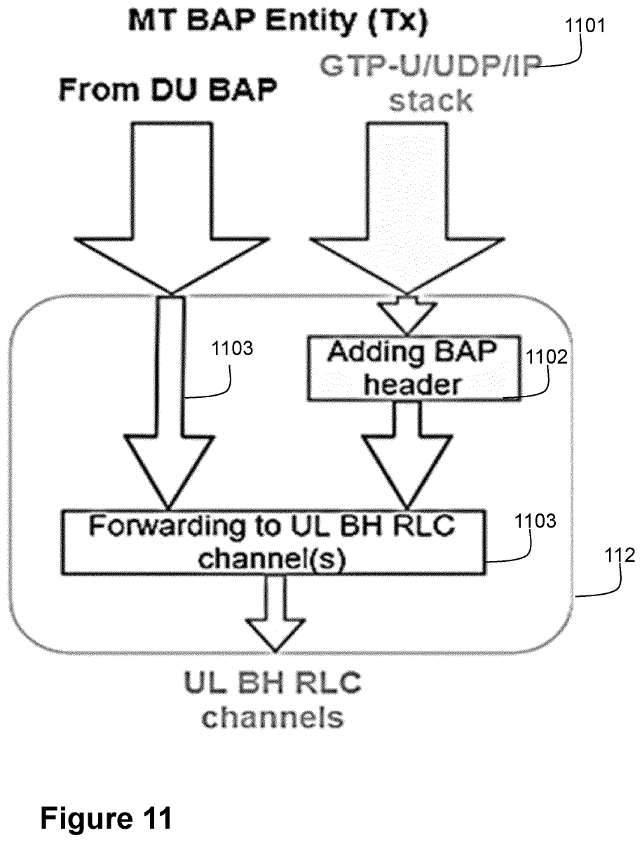

FIG. 11 is a schematic diagram illustrating a non-limiting example of the functions that may be performed by BAP entities for upstream transmission of the respective indication, in this case, from the second node 112, e.g., in a scenario such as that described in relation to FIG. 10, to the first node 111, according to Action 702. The PSU efficiency information may use the GTP-U/UDP/IP stack 1101 at the DU functionality of the second node 112. That is, it may be understood to be higher layer traffic for the GTP-U/U DP/IP protocol stack 1101 of the F1-U interface. Then, the GTP-U/UDP/IP stack 1101 at the DU functionality of the second node 112 may forward the second packet to the BAP entity at the IAB-MT. Using the GTP-U tunnel ID and/or IP address of the second packet, the IAB-DU BAP entity may check the mapping table, which may have been configured by the IAB-donor-CU, to select the correct uplink BH RLC channels and outgoing backhaul link at 1103. After that, the BAP layer may add a BAP header at 1102 that may include the BAP Routing ID of destination IAB-donor node and may forward the BAP PDU to the lower layer at 1103, that is, the RLC layer. Depending on the importance of the PSU/battery efficiency information, the IAB-donor may set a proper high or low priority BH RLC channel via BH RLC CH QoS IE value. The second node 112, may then map the respective indication either 1:1 or N:1 to the BH RLC channel. The second node 112, may not have a DU BAP because it may be understood to not serving any IAB node as a child node in this particular example. IAB nodes that serve other IAB nodes may be understood to need a DU BAP. The arrows in the figure indicate the peers for each protocol.

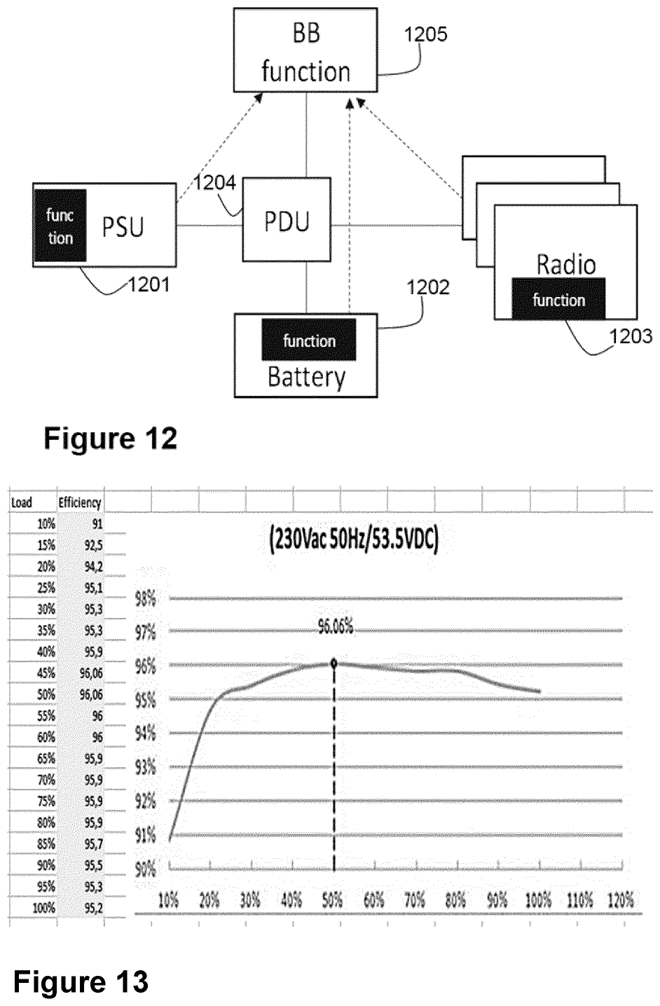

FIG. 12 is a schematic diagram illustrating how the second node 112 may gather the first measure of efficiency of its power supply unit, from a first function 1201 in its PSU, the second measure of efficiency of the battery unit of the second node 112 from a second function 1202 in its battery, and the third measure of efficiency of radio resources of the second node 112 from a third function 1203 in its radio unit. The first measure, the second measure and the third measure may be assembled in a PDU 1204 and forwarded to a Base Band (BB) function 1205 on each node, the donor node and IAB node, and later collected by the first node 111.

FIG. 13 is a graphic representation of how the PSU efficiency, represented in the vertical axis, depends on the load of a node, any of a donor node and an IAB node, represented in the horizontal axis. As may be observed in FIG. 13, the efficiency of the PSU may be increased with the load of a node, up to around 96.06% efficiency, after which, the efficiency plateaus, and slightly decreases with high loads. As explained earlier, the different IAB nodes, may have different distribution load from the PSU perspective. The load of the PSU, as may be appreciated in FIG. 13, may have a big impact on the efficiency of the communications network 100. According to embodiments herein, the first node 111 may be enabled to select paths based on information sent via BAP protocol, not only based on the efficient radio bearers, but also efficient PSU in conjunction to the radio bearers, improving the nodes total efficiency. This selection may allow the first node 111 to improve the efficiency and to operate on 96% efficiency, related to PSU operating conditions. By routing the first packet via the selected path in Action 503 considering operation efficiency and selecting the right load of the plurality of nodes 110, increasing the load in particular nodes, the efficiency may be increased from 93% to 96%. Therefore, a 3% efficiency in the communications network 100 may be gained.

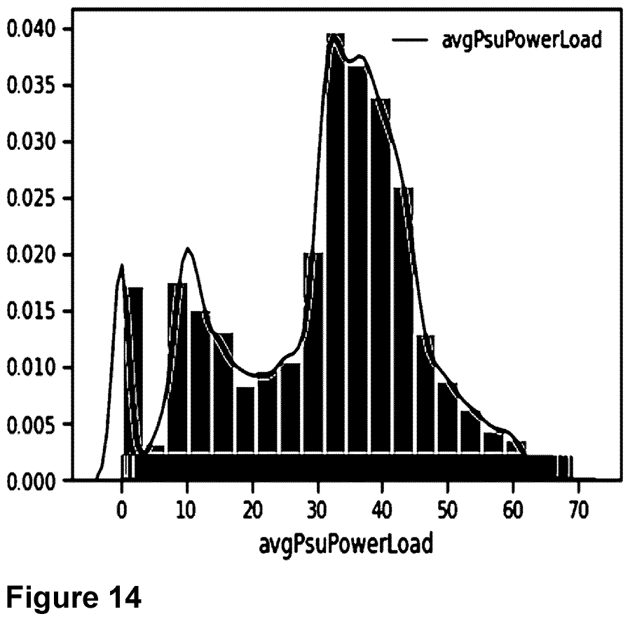

FIG. 14 is a graphic representation of the normalized distribution of the PSU average load, on each node, IAB donor or IAB node in an example network, wherein embodiments herein have not yet been implemented. The horizontal axis represents average PSU power load in %, of the maximum available power. The vertical axis represents a normalized value of the different load distribution on different PSU loads, in relation to the best operational efficiency 96,06 in FIG. 13, which is reached at 50% of the average PSU load. In FIG. 14, the avgPSUPowerLoad distribution peaks at 40% or less. That is, many nodes have a load which does not correspond to their maximum efficiency, based on the graphical representation of FIG. 13. In other words, in many nodes there may be inefficiency states in PSU, since their PSU distribution is not around 50%. By knowing this fact, the first node 111 may, according to embodiments herein, make decisions, on where to put UE, and where to route the data, from one end to another, to increase the efficiency in the communications network 100.

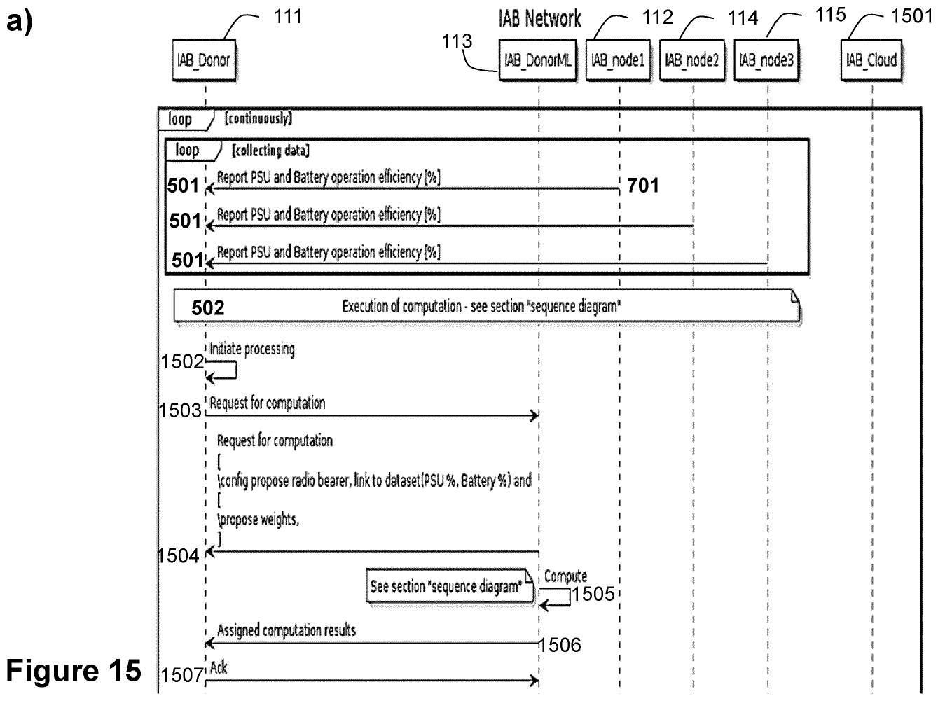

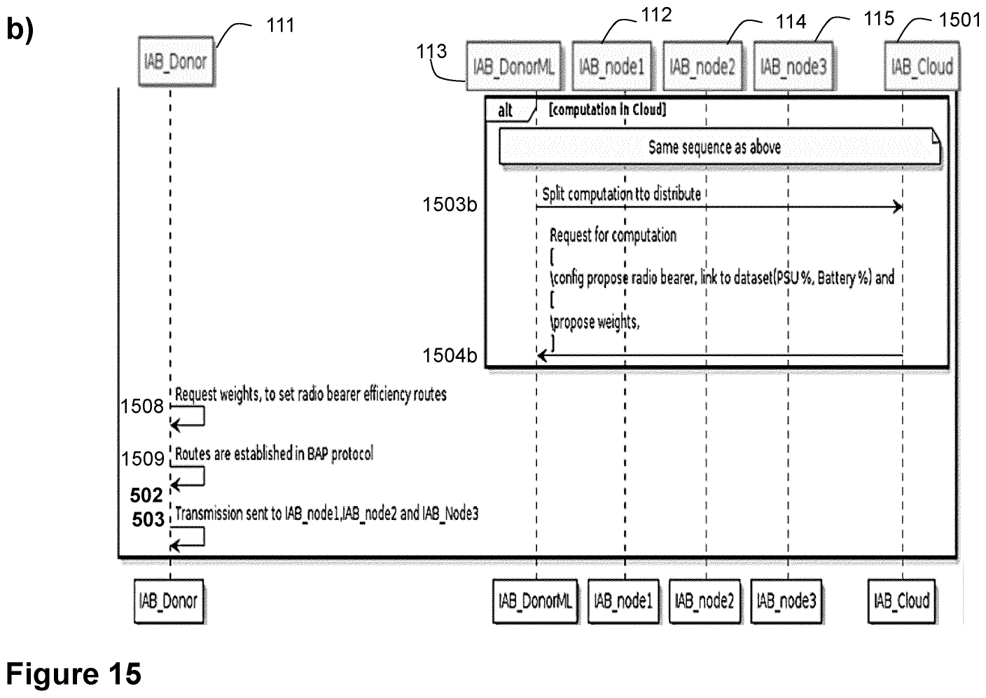

FIG. 15 is a signalling diagram depicting a non-limiting example of a method in the communications network 100, according to embodiments herein. In this non-limiting example, the plurality of nodes 100 may comprise the second node 112, as IAB_node1, the fourth node 114 as IAB_node2, and the fifth node 115 as IAB_node3. The first node 111 is the IAB_Donor and the third node 113 is co-localized with the first node 111 and is an IAB_DonorML. There may be a further node in the IAB_Cloud 1501. As is represented in panel a) of FIG. 15, each of the nodes in the plurality of nodes 110 may send, in accordance with Action 701, which each of the nodes may perform individually, their respective indication to the first node 111. The respective indication may comprise a report of PSU and battery operation efficiency [%]. This may loop continuously, whereby the first node 111 may obtain the respective indication from each of the second node 112, the fourth node 114 and the fifth node 115, and loop collecting data. In the next phase, the first node 111 may, according to Action 502, execute a computation to select the path for the first packet in the communications network 100, among the at least two paths 151, 152, based on the obtained respective indication. For better operational condition, in this non-limiting example, the first node 111 may initiate processing at 1502 by requesting, at 1503, that the third node 113 compute, using ML, the best performing route and propose selection of routes for the first node 111. To enable the third node 113 to evaluate the path to be selected to route the first packet, the first node 111 may provide, to the third node 113, the information it may have collected on the radio efficiency, the PSU efficiency and the battery efficiency, including the training sequence. The third node 113 may perform the computations at 1505, and report, the computation results back to the first node 111 at 1506, which may be acknowledged at 1507. The ML model may use historical trained data from PSU, battery and other QoS parameters for the processing. The machine-learning model output that is, the output data. may be derived in “weights”/output neurons from the Neural Network (NN). Based on the weights, the most efficient path/route may be decided. After the decision, this may be processed into the BAP protocol, on the IAB donor, to select the path of the UE data, through the communications network 100 of IAB nodes in, e.g., FIG. 9.

Panel b) of FIG. 15 is a continuation of the procedure described in panel a), and describes and alternative, wherein the same computations may be performed by another third node 1501 in the cloud 118. At 1503b, the third node 113 may split the computation to distribute, by requesting the computation for the radio bearer, the link to the dataset (PSU %, Battery %) and the proposed weights. That is, data may be fed into the NN as features to be processed, and the output of the NN, may be the most efficient path sent back via 1504b. At 1508, the first node 111 requests the weights, to set the radio bearer efficiency routes. Route selection may be understood to be made, based on the weights output by the NN. At 1509, in accordance with Action 502, the first node 111 selects the path to follow by the first packet and establishes the routes in the BAP protocol. At 503, the first node 111 finally routes the first packet by transmitting the first packet via the selected path, to the second node 112, the fourth node 114 and the fifth node 115.

As a summary overview of the foregoing, embodiments herein provide for methods and apparatus to enhance efficiency utilization of resources, including PSU and battery, in IAB architectures such as the communications network 100. Embodiments herein provide for new PSU and battery functionality reporting operational efficiency, which may then be included in the BAP protocol, and may be later sent to the IAB donor, setting up a better radio bearer, along the various routes, from a radio efficiency point of view.

Certain embodiments disclosed herein may provide one or more of the following technical advantage(s), which may be summarized as follows.

As a first advantage, embodiments herein may be understood to improve the operation efficiency of an IAB architecture on each radio bearer setup, and enable a total change of the infrastructure efficiency for various radio bearer streams in a multi-hop arrangement, at an onsite level on each of the relay nodes, the nodes in the plurality of nodes 100. Onsite level may be understood to mean that the PSU and battery may be included, according to embodiments herein, into the decision making, setting up the radio bearers along the IAB network. A site may be understood to includes several components, not only radio components, that may be taken into account. Existing methods for setting a radio bearer selection do not include the information and the efficiency information of the PSU and battery.

As another advantage, embodiments herein may be understood to enable the BAP protocol with a new symbol bit, of information of efficiency from relay nodes, to the donor, in the “return path”.

In general, embodiments herein may be understood to enable to improve IAB end-to-end efficiency.

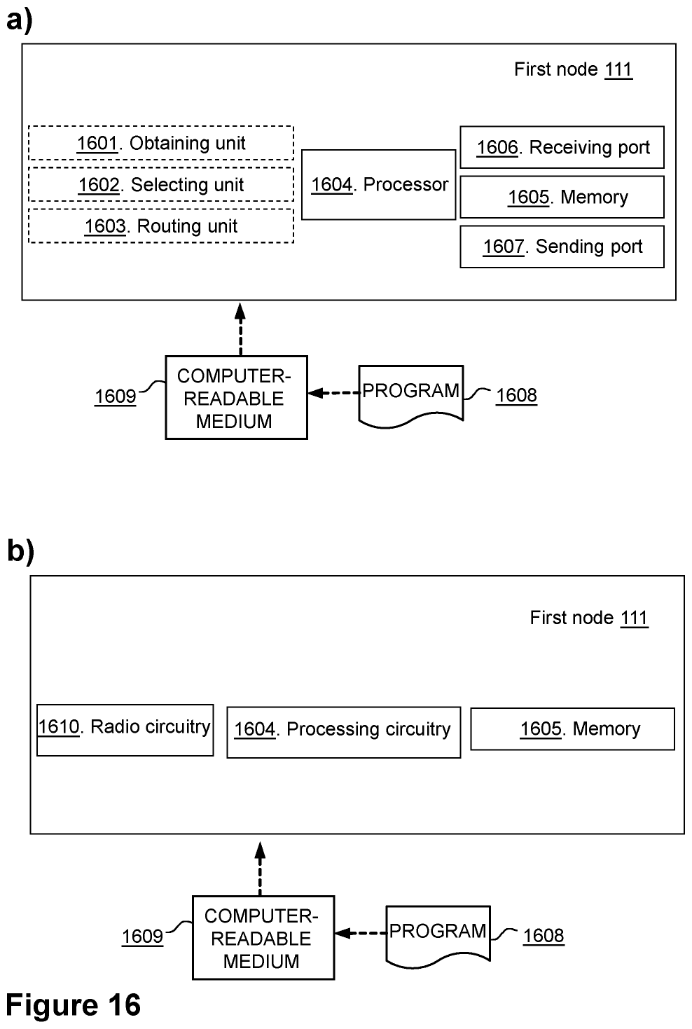

FIG. 16 depicts two different examples in panels a) and b), respectively, of the arrangement that the first node 111 may comprise. In some embodiments, the first node 111 may comprise the following arrangement depicted in FIG. 16a. The first node 111 may be for handling a path for a first packet in the communications network 100. The first node 111 is configured operate in the communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here to simplify the description. For example, in some embodiments, the first node 111 may be configured to be one of a donor IAB node and an intermediate IAB node, and the second node 112 may be configured to be an intermediate IAB node.

In FIG. 16, optional units are indicated with dashed boxes.

The first node 111 is configured to, e.g. by means of an obtaining unit 1601 within the first node 111, configured to, obtain, from the another node 112, 113 configured to operate in the communications network 100, the respective indication. The respective indication is of the respective efficiency measure of power use of the plurality of nodes 110 configured to operate in the communications network 100 along at least two paths 151, 152.

The first node 111 is also configured to, e.g. by means of a selecting unit 1602 within the first node 111, configured to, select the path for the first packet in the communications network 100, among the at least two paths 151, 152, based on the respective indication configured to be obtained.

In some embodiments, the respective efficiency measure of power use may be configured to comprise the first efficiency measure of the power supply unit of the respective node of the plurality of nodes 110 and the second efficiency measure of the battery unit of the respective node of the plurality of nodes 110.

In some embodiments, the respective indication may be further configured to indicate the respective third efficiency measure of radio resources of the respective node of the plurality of nodes 110.

The respective indication may be configured to be one of the following options. According to a first option, the respective indication may be the observed respective efficiency measure of power use configured to be obtained from the respective nodes in the plurality of nodes 110, wherein the another node may be configured to be a second node 112. According to a second option, the respective indication may be the predicted respective efficiency measure of power use configured to be obtained via the ML model to predict the respective efficiency measure of power use of the plurality of nodes 110, wherein the another node may be configured to be the third node 113. According to a third option, the respective indication may be the alarm with respect to one of the observed respective efficiency measure and the predicted respective efficiency measure.

The first node 111 may be configured to, e.g. by means of a routing unit 1603 within the first node 111, configured to, route the first packet via the path configured to be selected by mapping bearer data to a backhaul RLC channel.

In some embodiments, the respective indication may be configured to be comprised in a second packet configured to comprise a BAP header.

In some embodiments, the header may be configured to comprise a BAP routing ID of parent nodes in the path configured to be selected.

In some embodiments, the respective indication may be configured to be comprised in a non-F1-U packet.

In some embodiments, to obtain may be configured to be performed based on at least one of: a) the periodicity, and b) the change in the respective efficiency measure exceeding a threshold.

The communications network 100 may be configured to be an IAB network.

In some embodiments, the first node 111 may be configured to be one of a donor IAB node and an intermediate IAB node. The third node 113 may be configured to be one of the donor IAB node and another node in the cloud 118.

The embodiments herein in the first node 111 may be implemented through one or more processors, such as a processor 1604 in the first node 111 depicted in FIG. 16a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1605 comprising one or more memory units. The memory 1605 is arranged to be used to store obtained information, store data, configurations, schedulings, and applications etc. to perform the methods herein when being executed in the first node 111.

In some embodiments, the first node 111 may receive information from, e.g., the plurality of nodes, the second node 112, the third node 113, the fourth node 114, the fifth node 115, the sixth node 116, the seventh node 117, the wireless device 130, and/or any other node, through a receiving port 1606. In some embodiments, the receiving port 1606 may be, for example, connected to one or more antennas in first node 111. In other embodiments, the first node 111 may receive information from another structure in the communications network 100 through the receiving port 1606. Since the receiving port 1606 may be in communication with the processor 1604, the receiving port 1606 may then send the received information to the processor 1604. The receiving port 1606 may also be configured to receive other information.

The processor 1604 in the first node 111 may be further configured to transmit or send information to e.g., the plurality of nodes, the second node 112, the third node 113, the fourth node 114, the fifth node 115, the sixth node 116, the seventh node 117, the wireless device 130, and/or any other node, or another structure in the communications network 100, through a sending port 1607, which may be in communication with the processor 1604, and the memory 1605.

Those skilled in the art will also appreciate that the units 1601-1603 described above may refer to a combination of analog and digital circuits, and/or one or more processors configured with software and/or firmware, e.g., stored in memory, that, when executed by the one or more processors such as the processor 1604, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1601-1603 described above may be implemented as one or more applications running on one or more processors such as the processor 1604.

Thus, the methods according to the embodiments described herein for the first node 111 may be respectively implemented by means of a computer program 1608 product, comprising instructions, i.e., software code portions, which, when executed on at least one processor 1604, cause the at least one processor 1604 to carry out the actions described herein, as performed by the first node 111. The computer program 1608 product may be stored on a computer-readable storage medium 1609. The computer-readable storage medium 1609, having stored thereon the computer program 1608, may comprise instructions which, when executed on at least one processor 1604, cause the at least one processor 1604 to carry out the actions described herein, as performed by the first node 111. In some embodiments, the computer-readable storage medium 1609 may be a non-transitory computer-readable storage medium, such as a CD ROM disc, or a memory stick. In other embodiments, the computer program 1608 product may be stored on a carrier containing the computer program 1608 just described, wherein the carrier is one of an electronic signal, optical signal, radio signal, or the computer-readable storage medium 1609, as described above.

The first node 111 may comprise a communication interface configured to facilitate communications between the first node 111 and other nodes or devices, e.g., the plurality of nodes, the second node 112, the third node 113, the fourth node 114, the fifth node 115, the sixth node 116, the seventh node 117, the wireless device 130, and/or any other node. The interface may, for example, include a transceiver configured to transmit and receive radio signals over an air interface in accordance with a suitable standard.

In other embodiments, the first node 111 may comprise the following arrangement depicted in FIG. 16b. The first node 111 may comprise a processing circuitry 1604, e.g., one or more processors such as the processor 1604, in the first node 111 and the memory 1605. The first node 111 may also comprise a radio circuitry 1610, which may comprise e.g., the receiving port 1606 and the sending port 1607. The processing circuitry 1604 may be configured to, or operable to, perform the method actions according to FIG. 5, FIGS. 8-12 and/or FIG. 15, in a similar manner as that described in relation to FIG. 16a. The radio circuitry 1610 may be configured to set up and maintain at least a wireless connection with the plurality of nodes, the second node 112, the third node 113, the fourth node 114, the fifth node 115, the sixth node 116, the seventh node 117, the wireless device 130, and/or any other node. Circuitry may be understood herein as a hardware component.

Hence, embodiments herein also relate to the first node 111 operative to operate in the communications network 100. The first node 111 may comprise the processing circuitry 1604 and the memory 1605, said memory 1605 containing instructions executable by said processing circuitry 1604, whereby the first node 111 is further operative to perform the actions described herein in relation to the first node 111, e.g., in FIG. 5, FIGS. 8-12 and/or FIG. 15.

The communications network 100 may be configured to be an IAB network.

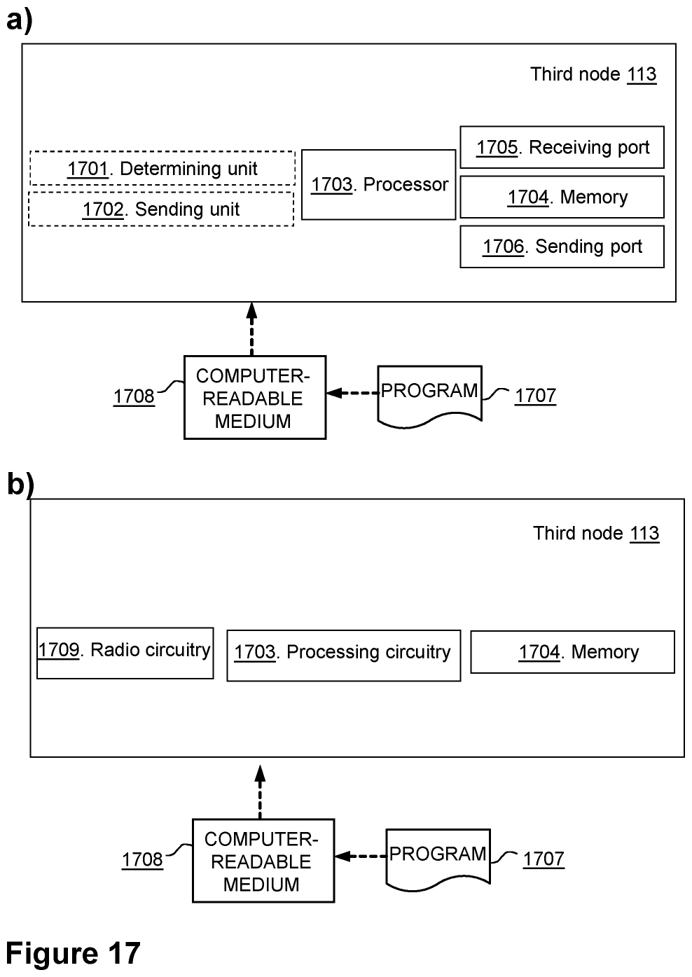

FIG. 17 depicts two different examples in panels a) and b), respectively, of the arrangement that the third node 113 may comprise. In some embodiments, the third node 113 may comprise the following arrangement depicted in FIG. 17a. The third node 113 may be understood to be for handling a path for a first packet in the communications network 100. The third node 113 is configured operate in the communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, in some embodiments, the third node 113 may be configured to be one of the donor IAB node and another node in a cloud 118. The first node 111 may be configured to be one of a donor IAB node and an intermediate IAB node.

In FIG. 17, optional units are indicated with dashed boxes.

The third node 113 is configured to, e.g., by means of a determining unit 1701 within the third node 113, configured to, determine, using a machine-learning model, the respective indication of the predicted respective efficiency measure of power use of the plurality of nodes 110 configured to operate in the communications network 100 along the at least two paths 151, 152.

The third node 113 is also configured to, e.g., by means of a sending unit 1702 within the third node 113, configured to, send, to the first node 111 configured to operate in the communications network 100, the respective indication of the respective efficiency measure of power use configured to be determined.

In some embodiments, the respective efficiency measure of power use may be configured to comprise the first efficiency measure of the power supply unit of the respective node of the plurality of nodes 110 and the second efficiency measure of the battery unit of the respective node of the plurality of nodes 110.

The respective indication may be further configured to indicate the predicted respective third efficiency measure of the radio resources of the respective node of the plurality of nodes 110.

The respective indication may be configured to be an alarm with respect to one of the observed respective efficiency measure and the predicted respective efficiency measure.

In some embodiments, to send the configured to be performed based on at least one of: a) the periodicity, and b) the change in the respective efficiency measure exceeding the threshold.

The embodiments herein in the third node 113 may be implemented through one or more processors, such as a processor 1703 in the third node 113 depicted in FIG. 17a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1704 comprising one or more memory units. The memory 1704 is arranged to be used to store obtained information, store data, configurations, schedulings, and applications etc. to perform the methods herein when being executed in the third node 113.

In some embodiments, the third node 113 may receive information from, e.g., the first node 111, the nodes in the plurality of nodes 110, the second node 112, the fourth node 114, the fifth node 115, the sixth node 116, the seventh node 117, the wireless device 130, and/or any other node, through a receiving port 1705. In some embodiments, the receiving port 1705 may be, for example, connected to one or more antennas in the third node 113. In other embodiments, the third node 113 may receive information from another structure in the communications network 100 through the receiving port 1705. Since the receiving port 1705 may be in communication with the processor 1703, the receiving port 1705 may then send the received information to the processor 1703. The receiving port 1705 may also be configured to receive other information.

The processor 1703 in the third node 113 may be further configured to transmit or send information to e.g., the first node 111, the nodes in the plurality of nodes 110, the second node 112, the fourth node 114, the fifth node 115, the sixth node 116, the seventh node 117, the wireless device 130, and/or any other node, or another structure in the communications network 100, through a sending port 1706, which may be in communication with the processor 1703, and the memory 1704.

Those skilled in the art will also appreciate that the units 1701-1702 described above may refer to a combination of analog and digital circuits, and/or one or more processors configured with software and/or firmware, e.g., stored in memory, that, when executed by the one or more processors such as the processor 1703, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1701-1702 described above may be implemented as one or more applications running on one or more processors such as the processor 1703.

Thus, the methods according to the embodiments described herein for the third node 113 may be respectively implemented by means of a computer program 1707 product, comprising instructions, i.e., software code portions, which, when executed on at least one processor 1703, cause the at least one processor 1703 to carry out the actions described herein, as performed by the third node 113. The computer program 1707 product may be stored on a computer-readable storage medium 1708. The computer-readable storage medium 1708, having stored thereon the computer program 1707, may comprise instructions which, when executed on at least one processor 1703, cause the at least one processor 1703 to carry out the actions described herein, as performed by the third node 113. In some embodiments, the computer-readable storage medium 1708 may be a non-transitory computer-readable storage medium, such as a CD ROM disc, or a memory stick. In other embodiments, the computer program 1707 product may be stored on a carrier containing the computer program 1707 just described, wherein the carrier is one of an electronic signal, optical signal, radio signal, or the computer-readable storage medium 1708, as described above.

The third node 113 may comprise a communication interface configured to facilitate communications between the third node 113 and other nodes or devices, e.g., the first node 111, the nodes in the plurality of nodes 110, the second node 112, the fourth node 114, the fifth node 115, the sixth node 116, the seventh node 117, the wireless device 130, and/or any other node, or another structure. The interface may, for example, include a transceiver configured to transmit and receive radio signals over an air interface in accordance with a suitable standard.

In other embodiments, the third node 113 may comprise the following arrangement depicted in FIG. 17b. The third node 113 may comprise a processing circuitry 1703, e.g., one or more processors such as the processor 1703, in the third node 113 and the memory 1704. The third node 113 may also comprise a radio circuitry 1709, which may comprise e.g., the receiving port 1705 and the sending port 1706. The processing circuitry 1703 may be configured to, or operable to, perform the method actions according to FIG. 6, FIGS. 8-12 and/or FIGS. 15, in a similar manner as that described in relation to FIG. 17a. The radio circuitry 1709 may be configured to set up and maintain at least a wireless connection with the the first node 111, the nodes in the plurality of nodes 110, the third node 113, the fourth node 114, the fifth node 115, the sixth node 116, the seventh node 117, the wireless device 130, and/or any other node. Circuitry may be understood herein as a hardware component.

Hence, embodiments herein also relate to the third node 113 operative to operate in the communications network 100. The third node 113 may comprise the processing circuitry 1703 and the memory 1704, said memory 1704 containing instructions executable by said processing circuitry 1703, whereby the third node 113 is further operative to perform the actions described herein in relation to the third node 113, e.g., in FIG. 6, FIGS. 8-12 and/or FIG. 15.

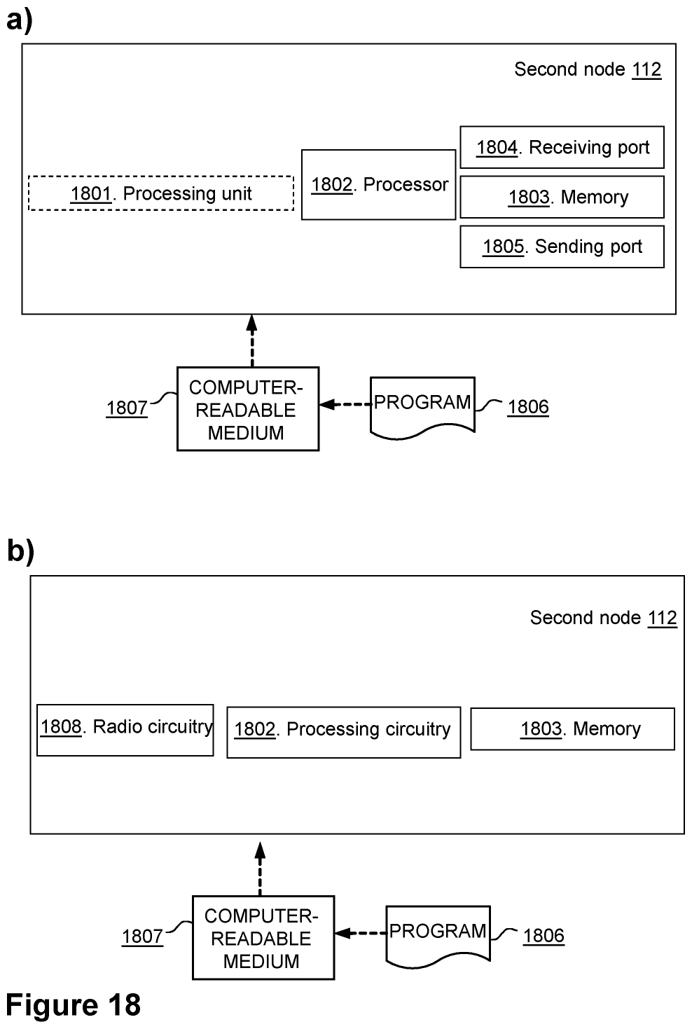

FIG. 18 depicts two different examples in panels a) and b), respectively, of the arrangement that the second node 112 may comprise. In some embodiments, the second node 112 may comprise the following arrangement depicted in FIG. 18a. The second node 112 may be understood to be for handling a path for a first packet in the communications network 100. The second node 112 is configured operate in the communications network 100.

The communications network 100 may be configured to be an IAB network.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, in some embodiments, the first node 111 may be configured to be one of a donor IAB node and an intermediate IAB node. The second node 112 may be configured to be an intermediate IAB node.

In FIG. 18, optional units are indicated with dashed boxes.

The second node 112 is configured to, e.g. by means of a sending unit 1801 within the second node 112, configured to send, to the first node 111 configured to operate in the communications network 100, the respective indication. The respective indication is of the respective efficiency measure of power use of the second node 112 configured to operate in the communications network 100 along one of at the least two paths 151, 152.

In some embodiments, the respective efficiency measure of power use may be configured to comprise at least one of: the first efficiency measure of the power supply unit of the second node 112 and the second efficiency measure of the battery unit of the second node 112.

In some embodiments, the respective indication may be further configured to indicate the respective third efficiency measure of radio resources of the second node 112.

In some embodiments, the respective indication may be configured to be the observed respective efficiency measure of power use configured to be obtained from the second node 112.

In some embodiments, the respective indication may be configured to be comprised in the second packet configured to comprise the BAP header.

In some embodiments, the header may be configured to comprise the BAP routing ID of the parent nodes in the path of the at least two paths 151, 152.

The indication may be configured to be comprised in the non-F1-U packet.

To send may be configured to be performed based on at least one of: a) the periodicity, and b) the change in the respective efficiency measure exceeding the threshold.

The embodiments herein in the second node 112 may be implemented through one or more processors, such as a processor 1802 in the second node 112 depicted in FIG. 18a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1803 comprising one or more memory units. The memory 1803 is arranged to be used to store obtained information, store data, configurations, schedulings, and applications etc. to perform the methods herein when being executed in the second node 112.

In some embodiments, the second node 112 may receive information from, e.g., the first node 111, the nodes in the plurality of nodes 110, the third node 113, the fourth node 114, the fifth node 115, the sixth node 116, the seventh node 117, the wireless device 130, and/or any other node, through a receiving port 1804. In some embodiments, the receiving port 1804 may be, for example, connected to one or more antennas in the second node 112. In other embodiments, the second node 112 may receive information from another structure in the communications network 100 through the receiving port 1804. Since the receiving port 1804 may be in communication with the processor 1802, the receiving port 1804 may then send the received information to the processor 1802. The receiving port 1804 may also be configured to receive other information.

The processor 1802 in the second node 112 may be further configured to transmit or send information to e.g., the first node 111, the nodes in the plurality of nodes 110, the third node 113, the fourth node 114, the fifth node 115, the sixth node 116, the seventh node 117, the wireless device 130, and/or any other node, or another structure in the communications network 100, through a sending port 1805, which may be in communication with the processor 1802, and the memory 1803.

Those skilled in the art will also appreciate that the unit 1801 described above may refer to a combination of analog and digital circuits, and/or one or more processors configured with software and/or firmware, e.g., stored in memory, that, when executed by the one or more processors such as the processor 1802, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different unit 1801 described above may be implemented as one or more applications running on one or more processors such as the processor 1802.

Thus, the methods according to the embodiments described herein for the second node 112 may be respectively implemented by means of a computer program 1806 product, comprising instructions, i.e., software code portions, which, when executed on at least one processor 1802, cause the at least one processor 1802 to carry out the actions described herein, as performed by the second node 112. The computer program 1806 product may be stored on a computer-readable storage medium 1807. The computer-readable storage medium 1807, having stored thereon the computer program 1806, may comprise instructions which, when executed on at least one processor 1802, cause the at least one processor 1802 to carry out the actions described herein, as performed by the second node 112. In some embodiments, the computer-readable storage medium 1807 may be a non-transitory computer-readable storage medium, such as a CD ROM disc, or a memory stick. In other embodiments, the computer program 1806 product may be stored on a carrier containing the computer program 1806 just described, wherein the carrier is one of an electronic signal, optical signal, radio signal, or the computer-readable storage medium 1807, as described above.

The second node 112 may comprise a communication interface configured to facilitate communications between the second node 112 and other nodes or devices, e.g., the first node 111, the nodes in the plurality of nodes 110, the third node 113, the fourth node 114, the fifth node 115, the sixth node 116, the seventh node 117, the wireless device 130, and/or any other node, or another structure. The interface may, for example, include a transceiver configured to transmit and receive radio signals over an air interface in accordance with a suitable standard.

In other embodiments, the second node 112 may comprise the following arrangement depicted in FIG. 18b. The second node 112 may comprise a processing circuitry 1802, e.g., one or more processors such as the processor 1802, in the second node 112 and the memory 1803. The second node 112 may also comprise a radio circuitry 1808, which may comprise e.g., the receiving port 1804 and the sending port 1805. The processing circuitry 1802 may be configured to, or operable to, perform the method actions according to FIG. 7, FIGS. 8-12 and/or FIG. 15, in a similar manner as that described in relation to FIG. 18a. The radio circuitry 1808 may be configured to set up and maintain at least a wireless connection with the the first node 111, the nodes in the plurality of nodes 110, the third node 113, the fourth node 114, the fifth node 115, the sixth node 116, the seventh node 117, the wireless device 130, and/or any other node. Circuitry may be understood herein as a hardware component.

Hence, embodiments herein also relate to the second node 112 operative to operate in the communications network 100. The second node 112 may comprise the processing circuitry 1802 and the memory 1803, said memory 1803 containing instructions executable by said processing circuitry 1802, whereby the second node 112 is further operative to perform the actions described herein in relation to the second node 112, e.g., in FIG. 7, FIGS. 8-12 and/or FIG. 15 9.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

When using the word “comprise” or “comprising” it shall be interpreted as non-limiting, i.e. meaning “consist at least of”.

A processor may be understood herein as a hardware component.

The embodiments herein are not limited to the above described preferred embodiments. Various alternatives, modifications and equivalents may be used. Therefore, the above embodiments should not be taken as limiting the scope of the invention.

### REFERENCES

1. 3GPP IAB Technical report TR 38.874, v. 16.0.0.
2. 3GPP TS 38.473, v. 16.4.0.
3. 3GPP TS 38.331, v. 16.3.1.

1. A computer-implemented method performed by a first node, the first node operating in a communications network, the method comprising:
obtaining, from another node operating in the communications network, a respective indication of a respective efficiency measure of power use of a plurality of nodes operating in the communications network along at least two paths; and
selecting a path for a first packet in the communications network, among the at least two paths, based on the obtained respective indication.

2-11. (canceled)

12. A computer-implemented method performed by a third node, the third node operating in a communications network, the method comprising:
determining, using a machine-learning model, a respective indication of a predicted respective efficiency measure of power use of a plurality of nodes operating in the communications network along at least two paths; and
sending, to a first node operating in the communications network, a respective indication of the determined respective efficiency measure of power use.

13-28. (canceled)

29. A first node, the first node being configured to operate in a communications network, the first node being further configured to:
obtain, from another node configured to operate in the communications network, a respective indication of a respective efficiency measure of power use of a plurality of nodes configured to operate in the communications network along at least two paths; and
select a path for a first packet in the communications network, among the at least two paths, based on the respective indication configured to be obtained.

30. The first node of claim 29, wherein the respective efficiency measure of power use is configured to comprise a first efficiency measure of a power supply unit of a respective node of the plurality of nodes and a second efficiency measure of a battery unit of the respective node of the plurality of nodes.

31. The first node claim 29, wherein the respective indication is further configured to indicate a respective third efficiency measure of radio resources of the respective node of the plurality of nodes.

32. The first node of claim 29, wherein the respective indication is configured to be one of:
an observed respective efficiency measure of power use configured to be obtained from the respective nodes in the plurality of nodes, wherein the another node is configured to be a second node,
a predicted respective efficiency measure of power use configured to be obtained via a machine-learning model to predict the respective efficiency measure of power use of the plurality of nodes, wherein the another node is configured to be a third node, or
an alarm with respect to one of the observed respective efficiency measure and the predicted respective efficiency measure.

33. The first node of claim 29, further configured to: route the first packet via the path configured to be selected by mapping bearer data to a backhaul Radio Link Control, (RLC) channel.

34. The first node of claim 29, wherein the respective indication is configured to be comprised in a second packet configured to comprise a Backhaul Adaptation Protocol, (BAP) header.

35. The first node of claim 34, wherein the header is configured to comprise a BAP routing ID of parent nodes in the path configured to be selected.

36. The first node of claim 29, wherein the respective indication is configured to be comprised in a non-F1-U packet.

37. The first node of claim 29, wherein to obtain is configured to be performed based on at least one of:
a periodicity, and
change in the respective efficiency measure exceeding a threshold.

38. The first node of claim 29, wherein the communications network is configured to be an Integrated Access Backhaul (IAB) network.

39. The first node of claim 38, wherein the first node is configured to be one of a donor IAB node and an intermediate IAB node, and wherein the third node is configured to be one of the donor IAB node and another node in a cloud.

40. A third node configured to operate in a communications network, the third node being further configured to:
determine, using a machine-learning model, a respective indication of a predicted respective efficiency measure of power use of a plurality of nodes configured to operate in the communications network along at least two paths; and
send, to a first node configured to operate in the communications network, a respective indication of the respective efficiency measure of power use configured to be determined.

41. The third node of claim 40, wherein the respective efficiency measure of power use is configured to comprise a first efficiency measure of a power supply unit of a respective node of the plurality of nodes and a second efficiency measure of a battery unit of the respective node of the plurality of nodes.

42. The third node of claim 40, wherein the respective indication is further configured to indicate a predicted respective third efficiency measure of radio resources of the respective node of the plurality of nodes-.

43. The third node of claim 40, wherein the respective indication is configured to be an alarm with respect to one of the observed respective efficiency measure and the predicted respective efficiency measure.

44. The third node of claim 40, wherein to send is configured to be performed based on at least one of:
a periodicity, and
a change in the respective efficiency measure exceeding a threshold.

45. The third node of claim 40, wherein the communications network is configured to be an Integrated Access Backhaul (IAB) network.

46. The third node of claim 45, wherein the first node is configured to be one of a donor IAB node and an intermediate IAB node, and wherein the third node is configured to be one of the donor IAB node and another node in a cloud.

47-56. (canceled)
